(19) United States
(12) Patent Application Publication
(10) Pub. No.: US 2025/0184406 A1
(43) Pub. Date: Jun. 5, 2025

(54) TECHNIQUES FOR SIMPLIFYING IDENTITY MANAGEMENT IMPLEMENTATIONS RELATED TO APPLICATION SUBSCRIPTION MANAGEMENT

(71) Applicant: OKTA, INC., SAN FRANCISCO, CA (US)

(72) Inventors: Damian Ezequiel SCHENKELMAN, Buenos Aires (AR); Matias Adrian WOLOSKI, Punta del Este (UY); Denise REY, Punta del Este (UY); Javier Alberto CENTURION, Buenos Aires (AR); José Fernando ROMANIELLO, Cordoba (AR); Sebastian IACOMUZZI, London (GB)

(21) Appl. No.: 18/526,417

(22) Filed: Dec. 1, 2023

(51) Int. Cl. H04L 67/55; G06Q 20/12

(52) U.S. Cl. CPC H04L 67/55; G06Q 20/127

(57) ABSTRACT

A data management system may receive a subscription schema for a version of an application associated with the data management system. The subscription schema may include a set of feature sets for a set of plans of the version of the application. The data management system may then configure an integration between the application and a transaction processing platform. Further, the data management system may configure one or more pipelines for the application via an identity management system and based on the subscription schema. Additionally, the data management system may generate an entitlement setup for the version of the application to be used by an entitlement management system. The data management system may then receive data via a request about a subscription plan for an account associated with the user. The entitlement management system may then authorize or deny the request based on the entitlement setup.

### FIELD OF TECHNOLOGY

The present disclosure relates generally to identity management, and more specifically to techniques for simplifying identity management implementations related to application subscription management.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

Some software as a service (SaaS) applications may support one or more plans for a respective version of the SaaS application. The plans may be different pricing plans for the version of the SaaS application (e.g., a free plan, a pro plan, and an enterprise plan). However, to connect the SaaS application to a transaction processing platform to control the different plans of an application and different versions of an application, a user may have to manually connect the features of the application to the transaction processing platform. Further, users may also have to build separate systems to enforce whether a user of an application is entitled to use features of the application based on the plan the user may be subscribed to. As such, the connection and enforcement of a SaaS application with different plans for different versions may be difficult and inefficient to implement and maintain over time.

### SUMMARY

A method is described. The method may include: receiving, by an identity management system that is a first subsystem of a data management system, data corresponding to a subscription schema for a first version of an application of multiple versions of the application associated with the data management system, the subscription schema including multiple feature sets for multiple plans of the first version of the application; configuring, by the identity management system, an integration between the application and a transaction processing and subscription management platform connected to the data management system; configuring, by the identity management system, one or more pipelines for the application in accordance with one or more parameters associated with the subscription schema for the first version of the application; generating, by the identity management system, an entitlement setup for the first version of the application based on the multiple feature sets for the multiple plans of the first version of the application, the entitlement setup being for an entitlement management system that is a second subsystem of the data management system and integrated with the identity management system; receiving, by the identity management system, data associated with a request to create, access, update, or remove a subscription plan for an account associated with a user via the one or more pipelines for the application; and authorizing or denying, via the entitlement management system, the request based on the entitlement setup for the first version of the application.

An apparatus is described. The apparatus may include one or more memories storing processor executable code, and one or more processors coupled with the one or more memories. The one or more processors may individually or collectively operable to execute the code to cause the apparatus to: receive, by an identity management system that is a first subsystem of a data management system, data corresponding to a subscription schema for a first version of an application of multiple versions of the application associated with the data management system, the subscription schema including multiple feature sets for multiple plans of the first version of the application; configure, by the identity management system, an integration between the application and a transaction process and subscription management platform connected to the data management system; configure, by the identity management system, one or more pipelines for the application in accordance with one or more parameters associate with the subscription schema for the first version of the application; generate, by the identity management system, an entitlement setup for the first version of the application based on the multiple feature sets for the multiple plans of the first version of the application, the entitlement setup being for an entitlement management system that is a second subsystem of the data management system and integrated with the identity management system; receive, by the identity management system, data associated with a request to create, access, update, or remove a subscription plan for an account associated with a user via the one or more pipelines for the application; and authorize or deny, via the entitlement management system, the request based on the entitlement setup for the first version of the application.

A non-transitory computer-readable medium is described. The non-transitory computer-readable medium may store instructions executable by at least one processor to: receive, by an identity management system that is a first subsystem of a data management system, data corresponding to a subscription schema for a first version of an application of multiple versions of the application associated with the data management system, the subscription schema including multiple feature sets for multiple plans of the first version of the application; configure, by the identity management system, an integration between the application and a transaction process and subscription management platform connected to the data management system; configure, by the identity management system, one or more pipelines for the application in accordance with one or more parameters associate with the subscription schema for the first version of the application; generate, by the identity management system, an entitlement setup for the first version of the application based on the multiple feature sets for the multiple plans of the first version of the application, the entitlement setup being for an entitlement management system that is a second subsystem of the data management system and integrated with the identity management system; receive, by the identity management system, data associated with a request to create, access, update, or remove a subscription plan for an account associated with a user via the one or more pipelines for the application; and authorize or deny, via the entitlement management system, the request based on the entitlement setup for the first version of the application.

Some examples described herein may further include operations, features, means, or instructions for: receiving, by the identity management system, an input associated with enabling a first plan of the first version of the application from the multiple plans of the first version of the application, where the input enables the subscription plan for the account associated with the user to be the first plan of the first version of the application; and updating, via the entitlement management system, the entitlement setup based on the input.

Some examples described herein may further include operations, features, means, or instructions for: receiving, by the identity management system via the integration between the identity management system and the transaction processing and subscription management platform, an indication of a change to the subscription plan for the account associated with the user from the first plan of the first version of the application to a second plan of the first version of the application from the multiple plans of the first version of the application; and updating, via the entitlement management system, the entitlement setup based on the change of the subscription plan for the account associated with the user from the first plan of the first version of the application to the second plan of the first version of the application.

Some examples described herein may further include operations, features, means, or instructions for: receiving, by the identity management system, data associated with a request, from the user associated with the account, to make use of at least one feature of a feature set of the subscription plan of the account associated with the user; determining, via the entitlement management system, that the at least one feature of the feature set of the subscription plan of the account for the first version of the application satisfies a threshold; and transmitting, to the user associated with the account from, an indication, from the identity management system, that the threshold of the at least one feature of the feature set of the subscription plan is satisfied, the indication including one or more options associated with changing the subscription plan of the account associated with the user to a different plan of the multiple plans of the first version of the application based on the threshold being satisfied.

Some examples described herein may further include operations, features, means, or instructions for: receiving, by the identity management system, data associated with a request, from the user associated with the account, to use a feature set of the subscription plan of the account associated with the user; determining, via the entitlement management system, that at least one feature of the feature set of the subscription plan of the account is unsupported based on the entitlement setup; and transmitting, to the user associated with the account, an indication, from the identity management system that the at least one feature of the feature set is unsupported by the subscription plan of the account, the indication including one or more options associated with changing the subscription plan of the account to a different plan of the multiple plans of the first version of the application that supports the at least one feature.

Some examples described herein may further include operations, features, means, or instructions for obtaining, from the entitlement management system, a token that includes at least a subscription identifier associated with the account, where authorizing or denying, via the entitlement management system, the request is based on the token.

In some examples described herein, receiving the data corresponding to the subscription schema may include operations, features, means, or instructions for importing the data corresponding to the subscription schema for the first version of the application, the data including the multiple feature sets for the multiple plans of the first version of the application, where the identity management system imports the data corresponding to the subscription schema for the first version of the application from an external service connected to the data management system.

In some examples described herein, configuring the one or more pipelines for the application may include operations, features, means, or instructions for receiving, by the identity management system, a first input associated with the one or more parameters that control which plans of the multiple plans of the first version of the application are available via the one or more pipelines.

In some examples described herein, configuring the one or more pipelines for the application may include operations, features, means, or instructions for: receiving, by the identity management system, a second input, from the user associated with the account; and enabling a first plan of the multiple plans of the first version of the application as the subscription plan of the account in accordance with the one or more pipelines, where authorizing or denying the request is based on the second input enabling the first plan of the first version of the application.

Some examples described herein may further include operations, features, means, or instructions for assigning, by the identity management system, a first plan of the multiple plans of the first version of the application as the subscription plan of the account associated with the user in accordance with the one or more pipelines, where authorizing or denying the request is based on the first plan being assigned as the subscription plan of the account.

In some described herein, authorizing or denying the request via the entitlement management system may include operations, features, means, or instructions for receiving, from the entitlement management system, a first indication of a user permission status obtained from an authorization service of the identity management system, the first indication of the user permission status being associated with the request and an organization permission status associated with the request.

In some examples described herein, the transaction processing and subscription management platform may be selected from multiple transaction processing and subscription management platforms associated with the identity management system of the data management system.

In some examples described herein, the integration between the application and the transaction processing and subscription management platform may be configured by an administrative user of the identity management system of the data management system.

In some examples described herein, a respective feature set for a respective plan of the first version of the application includes one or more features associated with a quantitative value, one or more features associated with a quantitative value and a corresponding to unit for the quantitative value, one or more features associated with a quantitative value and a corresponding period of time for the quantitative value, one or more features associated with a quantitative value and both a corresponding unit for the quantitative value and a corresponding period of time for the quantitative value, or any combination thereof.

In some examples described herein, a respective feature set for a respective plan of the first version of the application includes one or more features with a Boolean value indicating whether a respective feature is configured within the respective feature set of the respective plan of the first version of the application.

In some examples described herein, the entitlement setup generated by the identity management system defines which users or organizations are authorized to access one or more features of a respective plan of the multiple plans of the first version of the application.

In some examples described herein, at least one of the multiple feature sets includes one or more authentication features supported by the identity management system of the data management system.

### BRIEF DESCRIPTION OF THE DRAWINGS

FIG. 1A illustrates an example of a computing system that supports techniques for simplifying identity management implementations related to application subscription management in accordance with aspects of the present disclosure.

FIG. 1B illustrates an example of a block diagram that supports techniques for identity management implementations related to application subscription management in accordance with aspects of the present disclosure.

FIG. 2 through 5 show examples of data management systems that support techniques for identity management implementations related to application subscription management in accordance with aspects of the present disclosure.

FIGS. 6 and 7 show examples of user interfaces that support techniques for simplifying identity management implementations related to application subscription management in accordance with aspects of the present disclosure.

FIG. 8 shows an example of a process flow that supports techniques for simplifying identity management implementations related to application subscription management in accordance with aspects of the present disclosure.

FIG. 9 shows a block diagram of an apparatus that supports techniques for simplifying identity management implementations related to application subscription management in accordance with aspects of the present disclosure.

FIG. 10 shows a block diagram of a software module that supports techniques for simplifying identity management implementations related to application subscription management in accordance with aspects of the present disclosure.

FIG. 11 shows a diagram of a system including a device that supports techniques for simplifying identity management implementations related to application subscription management in accordance with aspects of the present disclosure.

FIG. 12 shows a flowchart illustrating methods that support techniques for simplifying identity management implementations related to application subscription management in accordance with aspects of the present disclosure.

### DETAILED DESCRIPTION

In some systems, software as a service (SaaS) applications may offer one or more plans for a version of a SaaS application. The one or more plans may define features accessible to a user that is subscribed to a respective plan. The one or more plans may also define the pricing or billing for an application which may be fixed, per user, per feature being used, or any combination thereof. For example, there may be a free plan, a pro plan, or an enterprise plan of a version of a SaaS application. In some examples, users or organizations subscribed to the free plan may have access to a subset of features of the SaaS application. Further, in some examples, users or organizations subscribed to the enterprise plan may have access to all the available features of the SaaS application. To ensure users or organizations only have access to the features of a respective plan that the user or organization subscribes to, SaaS applications may use some entitlement management. Entitlement management may enforce the entitlement (e.g., privileges, permissions, access rights) of an account of a user based on the plan of an application that the user is subscribed to. For example, if a user attempts to use a feature of an application that may be unsupported by the plan of the application that the user is subscribed to, the application may restrict the user from using the feature of the application.

Further, there may also be different versions of the SaaS application. It should be understood that the different versions of an application as described herein refer to subscription versions that define a set of plans of the application for a user or organization to subscribe to. As such, the term “versions” described herein may refer to updates to the plans of an application that a user or organization may be able to subscribe to. For example, a first version (e.g., a first subscription or pricing version) of the SaaS application may have a first set of plans and a second version (e.g., a second subscription or pricing version) of the SaaS application may have a second set of plans that are different from the first set of plans. That is, the plans of different versions of an application may include updates to the features available for users or organizations that subscribe to them for a SaaS application. For example, as an application is updated, additional features for the SaaS application may become available, and as such, the second set of plans may indicate which plans have access to the additional features. In another example, a developer may reconfigure (e.g., update) the plans of an application that a user may subscribe to by creating a different version. As such, in some examples, the entitlement management for a SaaS application may also change based on when a different version defines different plans for a SaaS application. Therefore, the entitlement management for a SaaS application may support different versions simultaneously. For example, users or organizations may use a first version or a second version, thus the entitlement management may support both the first version and the second version at the same time.

In some examples, such versions (e.g., subscription versions) and the respective plans for a version may be used by a system such as a data management system. The data management system may provide techniques for efficient and accessible management of the different plans of different versions of an application and the corresponding entitlement management for the different versions of the application. For example, an identity management system which may be a subsystem of the data management system may receive data corresponding to a subscription schema for a version of an application (e.g., a SaaS application) of a set of versions of the application that is associated with the data management system. The subscription schema may include a set of features for a set of plans of the version of the application. That is, the subscription schema may indicate a subset of features of the set of features that each respective plan of the set of plans supports. The identity management system may also configure an integration between the application and a transaction processing and subscription management platform connected to the data management system. Further, the identity management system may also configure one or more pipelines (e.g., user access pipelines, sign up/sign in pipelines, pricing pipelines) in accordance with one or more parameters associated with the subscription schema of the version of the application. The identity management system may then generate an entitlement setup for the version of the application that is based on the set of features for the set of plans of the version of the application. The entitlement setup may be for and used by an entitlement management system. Further the entitlement management system may be a subsystem of a set of subsystems of the data management system.

Based on such configurations, the identity management system may receive data associated with a request to create, update, or remove a subscription plan for an account associated with a user. The identity management system may also receive the data via at least one of the one or more pipelines for the application. Using data of the request, the entitlement management system of the data management system may then authorize or deny the request based on the entitlement setup of the version of the application. As such, the data management system may use the integration between the transaction processing and subscription management platform and the application, control the one or more pipelines of the application in the identity management platform, and include the entitlement management system to control the entitlement setup for different versions of the application. Therefore, the data management system may provide for an improved development of an application that has multiple different plans for multiple different versions. For example, application developers may be capable of using the data management system to implement and manage applications more efficiently. For example, developers may be capable of spending relatively less time when managing and developing applications and may make relatively fewer mistakes and introduce less security vulnerabilities when using the data management system, allowing them to deliver relatively more value to customers with a relatively higher level of confidence.

In some examples, to further enhance the management of applications, the data management system may be capable of managing updates to the entitlement setup of the application. As described herein, the enhanced management of applications may refer to an enhanced management of an entitlement model for applications implemented by developers either manually or automatically (e.g., via code as part of the logic of an application) via an entitlement management system. For example, the identity management system may receive an input indicating that a user or organization of an account subscribed to a first plan of the version of the application as the subscription plan for the account. In some other examples, the identity management system may receive an indication via the integration between the identity management system and the transaction processing and subscription management platform that indicates a change to the subscription plan for the account associated with the user or organization from a first plan of the version of the application to a second plan of the version of the application from the set of plans of the version of the application. As such, in either example the entitlement setup may be updated accordingly for the entitlement management system, which is a subsystem of the data management system, to ensure a user or organization of an account has access to the features of the plan they subscribe to (e.g., the subscription plan for the account of the user). Moreover, if a user or organization of an account attempts to make use of a feature unsupported by the subscription plan of the account associated with the user or organization, a feature that has reached a threshold limit, or both, the application may restrict the user or organization of the account from using such feature based on the entitlement setup of the application being used by the entitlement management system. Additionally, or alternatively, the identity management system may provide the user or organization of the account an option to update the subscription plan for the account to gain access to the feature the user or organization is attempting to access.

As such, the data management system may be capable of managing the entitlement setup of an application to be used by the entitlement management system such that the entitlement management system is capable of ensuring users of applications have the correct access based on the plan and version of an application the users or organizations are subscribed to. The data management system may also be capable of managing the integration between the application and the transaction processing and subscription management platform. Such capabilities and integration may allow the data management system to provide developers with efficient and reliable techniques of managing the plans and versions of applications.

Aspects of the disclosure are initially described in the context of a computing system. Additional aspects of the disclosure are described with reference to data management systems, user interfaces, and a process flow. Aspects of the disclosure are further illustrated by and described with reference to apparatus diagrams, system diagrams, and flowcharts that relate to techniques for simplifying identity management implementations related to application subscription management.

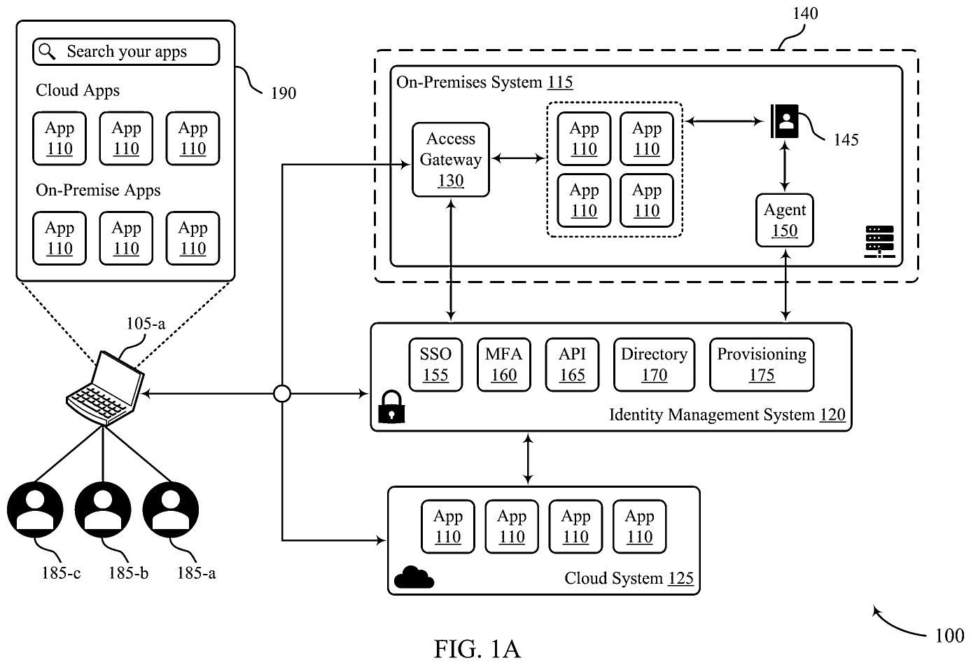

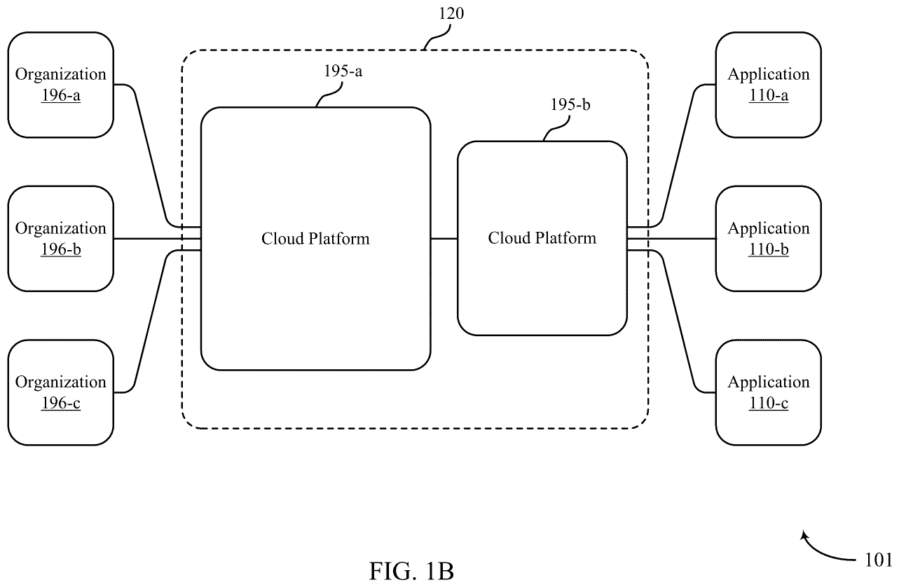

FIG. 1A illustrates an example of a computing system 100 that supports techniques for simplifying identity management implementations related to application subscription management in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 (e.g., a computing device 105-a) to communicate with one or more of the on-premises system 115, the identity management system 120, or the cloud system 125. For example, a user 185-a may access one or more applications 110 by interacting with an interface 190 of the computing device 105-a. That is, the user 185-a may be an end user of an application 110. In some implementations, the user 185-a may be prompted to provide some form of identification (such as a password, personal identification number (PIN), biometric information, or the like) before the interface 190 is presented to the user 185. In some implementations, a user 185 may be a developer user 185-b, customer, employee, an end user, vendor, an application administrator (e.g., a user 185-c), an IT administrator, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185-a to access multiple applications 110 with one or more credentials. Once authenticated, the user 185-a may access one or more of the applications 110 (for example, via the interface 190 of the computing device 105). That is, based on the identity management system 120 authenticating the identity of the user 185-a, the user 185-a may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185-a (e.g., an end user) may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185-a for one or more credentials (such as a password, PIN, biometric information, or the like) and the user 185-a may provide the requested authentication credentials to the IdP. In some implementations, the IdP may leverage the MFA service 160 for added security. The IdP may verify the user's identity by comparing the credentials provided by the user 185-a to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185-a based on successful authentication of the user's identity.

The IdP may send the security token to the computing device 105-a (e.g., the browser or application 110 running on the computing device 105-a). In some examples, the application 110 may be associated with a service provider (SP), which may host or manage the application 110. In such examples, the computing device 105-a may forward the token to the SP. Accordingly, the SP may verify the authenticity of the token and determine whether the user 185 is authorized to access the requested applications 110. In some examples, such as examples in which the SP determines that the user 185-a is authorized to access the requested application, the SP may grant the user 185-a access to the requested applications 110, for example, without prompting the user 185-a to enter credentials (e.g., without prompting the user to log-in). The SSO service 155 may promote improved user experience (e.g., by limiting the number of credentials the user 185-a has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185-a to provide multiple authentication factors before granting the user 185-a access to applications 110. These authentication factors may include one or more knowledge factors (e.g., something the user 185-a knows, such as a password), one or more possession factors (e.g., something the user 185=a is in possession of, such as a mobile app-generated code or a hardware token), or one or more inherence factors (e.g., something inherent to the user 185-a, such as a fingerprint or other biometric information). In some implementations, the MFA service 160 may be used in conjunction with the SSO service 155. For example, the user 185-a may provide the requested login credentials to the identity management system 120 in accordance with an SSO flow and, in response, the identity management system 120 may prompt the user 185-a to provide a second factor, such as a possession factor (e.g., a one-time passcode (OTP), a hardware token, a text message code, an email link/code). The user 185-a may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185-a) to interact with a client organization's APIs. The API service 165 may enable client organizations to implement customizable login experiences that are consistent with their architecture, brand, and security configuration. The API service 165 may enable administrators (e.g., application administrators) to control user API access (e.g., whether the user 185-a and/or one or more other users 185 have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1A, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

In some examples of the computing system 100, versions and plans of applications 110 may be used by a system such as a data management system. The data management system may provide techniques for efficient and accessible management of the different plans of different versions of an application 110 and the corresponding entitlement management for the different versions of the application 110. For example, the data management system may receive data corresponding to a subscription schema for a version of an application 110 of a set of versions of the application 110 that is associated with the data management system. The subscription schema may include a set of features for a set of plans of the version of the application 110. That is, the subscription schema may indicate a subset of features of the set of features that each respective plan of the set of plans supports. The data management system may also configure an integration between the application 110 and a transaction processing and subscription management platform connected to the data management system. Further, the data management system may also configure one or more pipelines (e.g., user 185 access pipelines, sign-up/sign-in pipelines, pricing pipelines) in accordance with one or more parameters associated with the subscription schema of the version of the application 110. The data management system may then generate an entitlement setup for the version of the application 110 that is based on the set of features for the set of plans of the version of the application 110. The entitlement setup may be for an entitlement management system to be used by the identity management system 120 or some other system, platform, or service to perform entitlement management of an application 110. Further the entitlement management system may be a subsystem of a set of subsystems of the data management system.

Based on such configurations, the data management system may receive data associated with a request to create, update, or remove a subscription plan for an account associated with a user 185-a (e.g., an end user) or organization. In some cases, the data management system may receive the data associated with the request via the integration between the application 110 and the transaction processing and subscription management platform. The data management system may also receive the data via at least one of the one or more pipelines for the application 110. Using data of the request, the entitlement management system of the data management system may authorize or deny the request based on the entitlement setup of the version of the application 110. As such, the data management system may use the integration between the transaction processing platform and the application 110, use the one or more pipelines of the application, and include the entitlement management system to implement the entitlement setup. Therefore, the data management system may provide for an enhanced development of an application that has multiple different plans for multiple different versions for developer users 185. For example, application 110 developers may be capable of using the data management system to manage applications 110 more efficiently.

In some examples of the computing system 100, to further enhance the management of applications 110 (e.g., the management of an entitlement model for applications), a data management system may be capable of managing updates to the entitlement setup of the application 110. For example, an identity management system which may be a subsystem of the data management system may receive an input indicating that a user 185-a (e.g., an end user) or organization of an account subscribed to a first plan of the version of the application 110 as the subscription plan for the account. In some other examples, the identity management system may receive an indication via the integration between the application 110 and the transaction processing and subscription management platform indicating that indicates a change to the subscription plan for the account associated with the user 185-a or organization from a first plan of the version of the application 110 to a second plan of the version of the application 110 from the set of plans of the version of the application 110. As such, in either example, the entitlement management setup may be updated accordingly for the entitlement management system, which is a subsystem of the data management system, to ensure a user 185-a or organization of an account has access to the features of the plan they subscribe to (e.g., the subscription plan for the account of the user). Moreover, if a user 185-a or organization of an account attempts to make use of a feature unsupported by the subscription plan of the account associated with the user, a feature that has reached a threshold limit, or both, the application 110 may restrict the user 185-a or organization of the account from using such feature of the application 110.

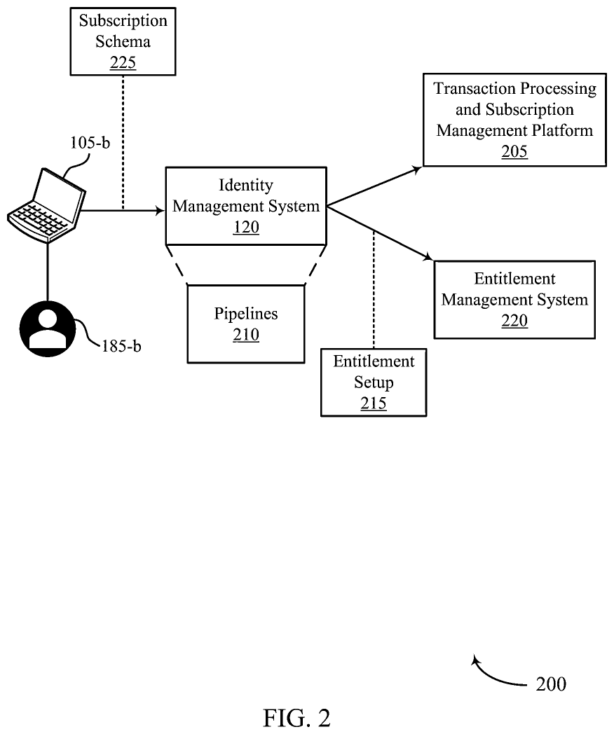

As such, the data management system may be capable of managing the entitlement setup of an application to be used by the entitlement management system such that the entitlement management system is capable of ensuring users of applications have the correct access based on the plan and version of an application the users are subscribed to. The data management system may also be capable of having an identity management system manage the entitlement setup of an application and update the entitlement setup based on a user changing plans or versions of an application. The data management system may also be capable of managing the integration between the application and the transaction processing and subscription management platform. Such capabilities and integration may allow the data management system to provide developer users with efficient and reliable techniques of managing the plans and versions of applications. The data management system is further described elsewhere herein, including with reference to FIGS. 2 through 8.

FIG. 1B illustrates an example of a block diagram 101 that supports techniques for simplifying identity management implementations related to application subscription management in accordance with aspects of the present disclosure. In some examples, the block diagram 101 may implement or be implemented by aspects of the computing system 100. For example, the block diagram 101 may be implemented at the identity management system 120 or one or more cloud platforms 195 (e.g., a cloud platform 195-a, a cloud platform 195-b), or both, which may be examples of the corresponding entities as described with reference to FIG. 1A. Further, in some examples, the one or more cloud platforms may be a part of, included within, or integrated with the identity management system 120.

In some examples, organizations 196 (e.g., an organization 196-a, an organization 196-b, an organization 196-c) may use cloud computing, such as cloud applications (e.g., an application 110-a, an application 110-b, an application 110-c), to increase a performance of the organization 196 (e.g., companies, enterprises). In some examples, the organizations 196 may employ the cloud platform 195-a (e.g., a workforce identity cloud) to manage authentication information across the multiple cloud applications (e.g., the applications 110). For example, the organizations 196 may use a quantity of technology vendors (e.g., ISVs) for internet, collaboration (e.g., within the organization and external to the organization), email, and billing, among other possible examples. Additionally, as a size of the organizations 196 increases, the organizations 196 may use more technology and, accordingly, an increased quantity of technology vendors. For example, the organizations 196 may utilize more resources, such as software applications (e.g., cloud applications), and may have multiple types of users of those resources, such as employees, contractors, and customers, among other examples. In some examples, the organizations 196 may implement one or more platforms (e.g., software platforms) for collaboration or for infrastructure, however, features provided by such platforms may fail to include some services to be implemented within the organization. That is, a likelihood of a single platform providing each service (e.g., all services, all applications) to be implemented within the organizations 196 may be relatively low and may constrain resources used by the organizations 196. For example, to reduce a quantity of platforms used by an organization, the organization may determine to constrain resources used by the organization to resources (or features) provided by a platform used by the organization for collaboration or for infrastructure (e.g., the platforms may become silos).

In some examples, the cloud platform 195-a (e.g., a workforce identity cloud) may enable increased performance for users (e.g., employees associated with respective IT teams or security teams within the organizations 196) across multiple stages of an identity lifecycle. For example, the cloud platform 195-a may enable the organizations 196 to complete projects relatively quickly, remediate security threats (e.g., in real time), and provide information to stakeholders associated with the organizations 196.

In some examples, the cloud platform 195-a may correspond to technology the organizations 196 may use to connect to multiple (e.g., all) resources. For example, the cloud platform 195-a may facilitate access to the applications 110 for the organizations 196, such that respective users (e.g., employees) associated with the organizations 196 may obtain suitable technologies for a suitable quantity of time (e.g., in a zero-trust environment). For example, access to a resource may lead to increased security risks for a workforce of an organization (e.g., one or more of the organizations 196). In such examples, the organization may use the cloud platform 195-a to enable multiple users (e.g., employees) associated with the organization access to multiple types of resources (e.g., techniques, such as cloud applications) to be used to complete work (e.g., jobs, tasks). For example, the cloud platform 195-a may correspond to an identity provider (e.g., a single identity provider, a single control plane, a single directory) for applications, systems, and tools, among other examples of resources, utilized within the organization. Additionally, or alternatively, the cloud platform 195-a may provide automation for identity compliance and business processes, including onboarding applications for users, onboarding users (e.g., employees), compliance reviews for users, role changes of users within the organization, and departures of users from the organization.

In some examples, it may be desirable for the applications 110 to support access management, extensibility, login security, and user management, among other possible features. For example, users of the applications 110 (e.g., users associated with the organizations 196) may wish to login to the applications 110 with multiple types of passwordless or social login methods. As described herein, enterprise-ready identity features may refer to identity features that may be suitable for organizations with constraints that may be distinct from consumer or relatively small business segments. In some examples, however, integrating enterprise-ready identity features into an application (e.g., one or more of the applications 110) may be relatively complex. Accordingly, some developers (e.g., ISVs) may determine to integrate (e.g., deploy) applications with the cloud platform 195-b. For example, developers of the applications 110 may use the cloud platform 195-b (e.g., a customer identity cloud) to deploy, and in some examples build, the applications 110.

For example, customer identity may impact how developers of applications may interact with users of the applications. In such an example, using the cloud platform 195-b to deploy the applications may lead to growth opportunities and increased brand recognition for the developers (e.g., business developing the applications). For example, it may be desirable for developers to build differentiated products, however maintaining and integrating differentiated products (e.g., tools, passwordless standards, other types of features) into applications may be relatively complex and time consuming, which may lead to reduced productivity and reduced innovation. As such, developers may use the cloud platform 195-b to deploy (e.g., and build) the applications 110 (e.g., consumer applications, SaaS applications) thereby reducing the burden associated with building and maintaining identity for the applications 110. That is, the cloud platform 195-b (e.g., a customer identity cloud) may enable application developers, digital leaders, and security teams to allocate more resources to innovation.

In some examples, the cloud platform 195-b may support customer identity solutions which may accelerate business, without necessitating that users sort through multiple feature functions. For example, the cloud platform 195-b may support flexible identity services. In some examples, the cloud platform 195-b may provide security for the applications 110 and increase convenience associated with using the applications 110. For example, developers of an application (e.g., digital teams associated with an ISV of one or more of the applications 110) may increase revenues through use and reuse of the application (e.g., by users of one or more of the organizations 196, customers), while maintaining security protections. Accordingly, the cloud platform 195-b (e.g., a customer identity cloud) may provide a framework the digital teams (e.g., developing consumer applications) to simplify registration and login across multiple devices, stacks, and platforms, for increased customer acquisition and retention, increased user experience, and a fuller view of user data. For example, the cloud platform 195-b may provide multiple features to aid the digital teams in increasing a digital experience associated with the application. For example, the cloud platform 195-b may provide a customizable user experience for the applications 110 including no-code or low-code universal login and multiple types of social and passwordless login options. As described herein, no-code may refer to development of a software application or features in which a developer (or manager) of the feature or application may be unaware how associated coding for the development may work and low-code may refer to development of a software application of feature in which a developer (or manager) of the feature or application may use some (e.g., a relatively low quantity) of code to customize the feature or application. Additionally, or alternatively, the cloud platform 195-b may provide personalization through progressive profiling, which may enable developers of the applications (e.g., marketers) to collect first-party data over time.

In some examples, the cloud platform 195-b may provide for accelerated growth of developers which may develop applications for organizations (e.g., for companies with business customers). For example, some software platforms may provide constrained feature options for companies with business customers (e.g., SaaS companies, companies developing SaaS applications), and product and engineering teams of such companies may rely on multiple software platforms (e.g., some combination of consumer and workforce identity solutions) to obtain a set of desired features for applications (e.g., SaaS applications) developed by the companies. Accordingly, the cloud platform 195-b may provide multiple (e.g., different) tools for such companies to develop applications, such as SaaS applications or other types of applications, which may be enterprise-ready. For example, the cloud platform 195-b may provide multiple tools for enterprise federation and other identity systems which may provide relatively easy to implement functionality and reliable and dynamic scaling to satisfy constraints of enterprise customers. That is, the cloud platform 195-b may enable developers to obtain enterprise-level identity features relatively fast and relatively easily. The cloud platform 195-b may evolve, such that the cloud platform 195-b may accommodate changes in standards (e.g., de-facto enterprise standards, such as service organization control 2 (SOC2) standards) and functionality. For example, the cloud platform 195-b may provide sets of identity capabilities, including future sets of identity capabilities, for developers (e.g., SaaS developers) that may use SSO and passwordless access.

For example, developers (e.g., a company, an ISV) of the application 110-a may use the cloud platform 195-b to integrate customer identity within the application 110-a (e.g., a marketing stack or other infrastructure associated with the application 110-a), which may enable the application 110-a to support open standards, pre-built integrations, multiple SDKs, multiple APIs, extensibility, and deployment in public or private clouds. In some examples, by using the cloud platform 195-b for customer identity associated with the application 110-a, the developers of the application 110-a may use less time (e.g., a relatively shorter duration) on identity management and more time (e.g., a relatively longer duration) on innovation.

In some examples, customer identity may encompass privacy, security, and experience. Accordingly, to support customer identity, the cloud platform 195-b may enable developers to improve user experience and satisfy regulatory compliance, while providing increased security. For example, the cloud platform 195-b may include a security center which may provide increased visibility to developers. For example, the security center may enable monitoring (e.g., real-time monitoring), detection, and response to potential identity security events (e.g., directly, such as through a dashboard or by integrating with one or multiple security stacks, or both).

In some examples, the organizations 196 and the developers of the applications 110 may use the identity management system 120, which may integrate and provide interoperability between the features (e.g., the workforce identity features) provided by the cloud platform 195-a (e.g., a workforce cloud) with the features (e.g., the customer identity features) provided by the cloud platform 195-b (e.g., a customer identify cloud). For example, the identity management system 120 (e.g., an integration network) may be an example of an identity provider (e.g., a single identity provider) across the organizations 196 and the applications 110 (e.g., used by the organizations 196) with increased resiliency and uptime for the cloud platforms 195 (e.g., reliability of about 99.99% uptime).

In some examples, the identity management system 120 may provide infrastructure reliability and one or more opportunities for feature (e.g., product, technology) connections across the cloud platforms 195. For example, the identity management system 120 (e.g., a unified identity platform) may correspond to a common integration layer in which technologies may be available to users (e.g., users associated with the organizations 196 and developers of the applications 110) across the cloud platforms 195. For example, the identity management system 120 may support no-code automation (e.g., workflows) across the cloud platforms 195. In some examples, providing workflows (e.g., automated proactive measures and responses) across the cloud platforms 195 may enable more extensibility and provide customizability for the organizations 196 and the applications 110.

In some examples, by supporting integration and interoperability across the cloud platforms 195, the identity management system 120 (e.g., an integration network) may enable the organizations 196 (e.g., workforce customers) to connect to improved cloud solutions and increase businesses, while maintaining security protections through enterprise-grade capabilities. Additionally, or alternatively, by supporting integration and interoperability across the cloud platforms 195, the identity management system 120 may provide developers of the applications 110 (e.g., SaaS companies) with relatively fast enterprise-readiness, exposure to multiple users (e.g., users associated with the organizations 196, tens of thousands of workforce customers), and information regarding use of the applications 110. For example, with multiple applications (e.g., thousands of SaaS applications) built using the cloud platform 195-b and integrated with the cloud platform 195-a, which may be used by multiple organizations 196 (e.g., tens of thousands of organizations), the identity management system 120 may provide a hub for an increased quantity of data and insights. Such data may provide one or more benefits for developers of the applications 110 and for the organizations 196 using (e.g., adopting) the applications 110. For example, the applications 110 may obtain insights (e.g., information, analytics, statistics) regarding which of the applications 110 the organizations 196 may be using and which of the applications 110 may be exposed (e.g., via APIs) to developers of the applications 110. The developers may use the insights to customize experiences for the organization 196 using the identity management system 120. For example, the identity management system 120 (e.g., an integration network) may provide the organizations 196 with improved integrations, which may enable increased development of the applications 110 (e.g., SaaS applications) and may lead to an increased quantity of insights (e.g., data, analytics associated with use of the applications 110).

In some examples, the identity management system 120 may provide a bridge between the organizations 196 (e.g., enterprises) using the cloud platform 195-a and the applications 110 (e.g., SaaS applications). For example, the organization 196-a may implement (e.g., adopt) the application 110-a using the cloud platform 195-a (e.g., to obtain the SSO integration). That is, an employee within the organization 196-a may use a dashboard (e.g., via a client device) to request access to the application using an SSO. In such an example, the cloud platform 195-a may connect to the cloud platform 195-b, which may be the identity provider the application 110-a uses for authentication. That is, the identity management system 120 may manage both sides of an authentication pathway (e.g., a process flow for authentication) used by the organization 196-a to access the application 110-a. In some examples, by managing both sides of the authentication pathway the identity management system 120 may provide improved identity practices for multiple industries.

In some examples, the identity management system 120 may enable the applications that may be built using the cloud platform 195-b to be accessed using the cloud platform 195-a. That is, developers may use the cloud platform 195-b to build the applications 110 and integrate the applications 110 with the cloud platform 195-a, such that users of the cloud platform 195-a may access the applications 110. Additionally, or alternatively, the identity management system 120 may enable the developers of the applications 110 to satisfy enterprises identity constraints and provide the developers with information and tools for building enterprise-ready applications. For example, the identity management system 120 may include content designed to aid developers of the applications 110 (e.g., SaaS builders) in achieving identity solutions. As described herein, identity solutions may refer to features which may be used to solve problems associated with managing credentials or other identifying information. The identity management system 120 may provide for relatively safer organizations (e.g., enterprises) and increased innovation for SaaS ecosystems.

For example, the organizations 196 may use the identity management system 120 to integrate the applications 110 (e.g., cloud applications) used at the organizations 196 and to centralize identity within the identity management system 120, for example rather than individually managing identity within each of the applications 110. That is, the identity management system 120 may be connected to each application 110 used at the organizations 196. In some examples, by connecting to multiple applications used at the organizations 196, the organization 196 may select applications 110 (e.g., technologies) suitable for the business of the organization while maintaining security, usability, and productivity, among other examples. That is, the identity management system 120 may provide relatively independent identity and neutrality among one or more of the applications 110. The identity management system 120 may connect and integrate the applications 110, such that identity may be independent (e.g., separate) from the applications 110. That is, by using the identity management system 120, users of the applications 110 may refrain from managing multiple (e.g., separate) credentials for each of the applications 110. In some examples, the identity management system 120 may provide one or more alternatives to monolithic technology stacks. That is, the identity management system 120 may provide an identity solution across multiple stacks and multiple sets of cloud applications. For example, the identity management system 120 may provide a framework for customizable technology within an organization, such that technology utilized within the organization may be suitable for the business of the organization. That is, the identity management system 120 may enable the organizations 196 to utilize multiple (e.g., different) ISVs for multiple (e.g., different) types of technology.

In some examples, the identity management system 120 may be referred to as a software platform or an integration network. For example, the identity management system 120 may provide a mapping of a cloud access ecosystem in which identity may be integrated across the cloud access ecosystem. That is, the identity management system 120 (e.g., the integration network) may connect the organizations 196 (e.g., users associated with the organization) to multiple applications 110 within the identity management system 120 (e.g., a cloud access ecosystem).

In some examples, as organizations evolve (e.g., acquiring businesses, add resources), managing identity may become relatively more complex (e.g., for IT teams and digital management teams within the organization) and may necessitate management of identity across multiple cloud applications, systems, and devices, among other examples. For example, to be relatively agile and nimble, employees of the organization (e.g., a workforce) may wish to utilize multiple types of technologies (e.g., securely) to increase performance (e.g., drive better business outcomes) and developers of technologies (e.g., applications) may wish to develop relatively long-term relationships with the organization (e.g., customers). In some examples, development of such relationships may begin at a login box used by the employees of the organization to access an application.

In some examples, the identity management system 120 may provide a framework to connect identity across multiple aspects of an organization and may enable management of security parameters associated with the organization (e.g., employees, contractors, and vendors) across a range of endpoints and devices. That is, using the identity management system 120, a workforce of the organization may access resources securely and seamlessly, irrespective of whether the workforce may access the resources using on-premises or cloud applications, cloud servers, databases, or containers, among other examples.

Additionally, or alternatively, developers (or other users, such as contractors) of the applications 110 may use the cloud platform 195-b to improve digital experiences and improve innovation. That is, the cloud platform 195-b may provide the organizations 196 and developers of the applications 110 with access to customizable and extensible technology and increased security reliability.

In some examples, the identity management system 120 may provide features for identity management including anything-as-a-source (XaaS), in which the identity management system 120 may connect to multiple sources of truth (e.g., any source of truth including sources of truth without integrations) and, for example, leverage existing resources (e.g., existing human resources systems) as a source capability. As described herein, a source of truth may refer to an aggregation of data from multiple systems within an organization to a single location. That is, users of the applications 110 (e.g., one or more of the organizations 196) with unsupported human resources systems may use the identity management system 120 to realize one or more benefits of XaaS. For example, XaaS may enable the organizations 196 to integrate multiple (e.g., any) sources of truth with the identity management system 120, which may lead to one or more benefits for human resource-driven provisioning from the multiple sources of truth. In some examples, XaaS features provided by the identity management system 120 may provide the organizations 196 with flexibility to determine (e.g., define, identity, select) terms of synchronization between the identity management system 120 and one or multiple sources of truth.

For example, identity management system 120 (e.g., a unified identity platform) may enable the organizations 196 with extended business ecosystems, by combining identity and access management features, identity and access governance features, and privileged access management features through a cloud-native control plane, which may lead to enterprise agility and increased IT productivity. In some examples, the identity management system 120 may be extensible, flexible, and may support multiple users, sources, and resources, including future users, future sources, and future resources. Additionally, or alternatively, the identity management system 120 may be relatively easy to use and may improve governance and privileged access, by providing features for administrators and users (e.g., of the organizations 196) and aligning multiple workstreams. In some examples, the identity management system 120 may provide unified features for reliability, scalability, and security.

In some examples, identity governance supported by the identity management system 120 may include lifecycle management, which may correspond to a capability to connect to identity sources (e.g., human resource systems) and use the identity sources as a single source of truth. Additionally, or alternatively, the identity governance supported by the identity management system 120 may include access requests, which may correspond to a request and approval process that enables users associated with the organizations 196 to request and approve access to resources using one or more applications (e.g., common chat-based applications). In some examples, the identity governance supported by the identity management system 120 may include access certification, which may provide governance policies and audit reporting. Additionally, or alternatively, the identity governance supported by the identity management system 120 may include workflows, which may provide capabilities for identity automation and orchestration with low-code or no-code.

In some examples, the XaaS capabilities supported at the identity management system 120 may include human resources as a Source functionality to automate IT processes associated with a user (e.g., an individual) joining, moving within, or leaving the organizations 196. For example, some human resources as a source systems may constrain organizations to use a human resources system with an existing integration network or an on-premises deployment. In some other examples, the XaaS capabilities supported at the identity management system 120 may provide human resources as a source capability (or multiple source capabilities) to multiple sources of truth (e.g., any source of truth). For example, the identity management system 120 may provide an API, which the organizations 196 may use to send data from a source (e.g., to the identity management system 120) and use a human resources system as a source capability included in the identity management system 120, such as user confirmation, user matching and linking, profile mappings, and import monitoring, among other examples. In some examples, using the identity management system 120 for human resource services may enable users to write custom connectors or leverage workflows to identities from multiple sources.

In some examples, the identity management system 120 may support a single selection configuration option (e.g., push button), which may be referred to as a one-click configuration, within the cloud platform 195-b. For example, after developers may build a resource (e.g., a website, application, identity feature, security feature) using the cloud platform 195-b, the developers may determine to integrate the resource (e.g., publish the application to) the cloud platform 195-a. In such an example, the developer may use the one-click to synchronize metadata from cloud platform 195-b (e.g., a process used to build the resource) with the cloud platform 195-a (e.g., a marketplace with public applications), for example without providing information to the cloud platform 195-a or the cloud platform 195-b (e.g., without completing forms within the cloud platform 195-a, such as using an integration network manager). In some examples, such a process may reduce complexities and increase a rate of development for ISVs (e.g., and integration network operations). In some examples, synchronization between the cloud platform 195-b and the cloud platform 195-b using the one-click may be performed for multiple types of applications, such as private applications that may be built externally from the cloud platform 195-b. In such examples, ISVs may share configured applications with automatic metadata synchronization between the cloud platform 195-b and the cloud platform 195-b using the one-click configuration. In some examples, the one-click configuration may be accessible via a dashboard (e.g., an administered dashboard) provided by the identity management system 120.

In some other examples, using the one-click configuration supported at the identity management system 120, ISVs may automate the configuration of an identity provider using reduced (e.g., minimal) user input. For example, using the identity management system 120, the ISVs may begin a registration process based on an email address associated with the user (e.g., using a tool provided by the identity management system 120 for attaching information to an email address or other online resources) or by requesting the user to enter a FastFed Discovery Endpoint. In such an example, in response to beginning the registration process an IT administrator (or other user associated with the organization) may be redirected to the associated identity provider (e.g., the identity management system 120), which the IT administrator may use to confirm the registration process. In some examples, after completing the registration process, resources may be created (e.g., the application may become integrated into the identity management system 120 and the identity management system 120 may become registered as the identity provider. In such an example, a connection (e.g., a communication channel) may be established for use in signing key rotation and other (e.g., future) scenarios. In some examples, the software identity management system 120 may support safer shadow IT. For example, configuring SSO may, in some examples, be performed by the IT administrator, which may lead to one or more issues, for example if an application has not been onboarded. In some examples, the IT administrator may use a free-tier or on a trial account to configure SSO, which may lead to one or more security risks. Additionally, or alternatively, the company may lack visibility of applications used by the employees.

Additionally, or alternatively, the identity management system 120 may support SAML and a system for cross-domain identity management (SCIM) using the one-click configuration and provisioning. For example, the identity management system 120 may provide an extension of SAML in one-click in which the identity management system 120 may provision users and groups to an application (e.g., a SaaS application) In some examples, the extension of the SAML may also provide for SCIM for provisioning (e.g., which may be part of one or more specifications, such as FastFed specifications). In some examples, the one-click configuration and provisioning may enable IT administrators (e.g., or other users associated with an organization) to enable SSO for user and automate provisioning and deprovisioning (e.g., of the applications or resources within the applications) to the users (e.g., single users or groups of users). In some examples, the identity management system 120 may be used as an identity graph. For example, some ISVs may refrain from (or may be incapable of) using an identity provider to add users and groups to applications. For example, the ISVs may use a synchronization process or choose to query the identity provider (e.g., in real time) to avoid using a local copy of the data (e.g., and managing synchronization and conflicts). In such examples, the ISVs may use the identity management system 120 (e.g., the one-click configuration supported by the identity management system 120), which may enable the ISVs to request read access to a directory of the organizations. In such an example, the ISVs may query users and groups using a graph API (e.g., via the identity management system 120). Additionally, or alternatively, the identity management system 120 may include endpoints, which may provide the ISVs with a stream of changes that may be used during the synchronization process. For example, the ISVs may use the stream (e.g., data) for features (e.g., a people picker).

In some examples, the identity management system 120 may support a marketplace in which ISVs that use the identity management system 120 may offer advanced capabilities (e.g., as part of applications) to users (e.g., in the marketplace). For example, a user may use an application (e.g., a SaaS application) from the marketplace. In such an example, IT administrators may be capable of installing applications from within the marketplace. In some examples, the installation may establish a connection (e.g., a channel) to the application. For example, the connection may occur between an account within the application and the directory associated with the organization. In some examples, the identity management system 120 may provide subscription and license management features which may integrate with one or more IGA capabilities, including future IGA capabilities. In some examples, in response to installing an application the IT administrator may be provided an option to connect to the identity management system 120 (e.g., may be provided with the one-click configuration).

In some examples, to use one or more features supported by the identity management system 120, the ISVs may be constrained to support and maintain standards (e.g., FastFed standards), SAML, and SCIM. Additionally, or alternatively, as FastFed adoption increases, the ISVs may create and maintain increased quantity (or different) integrations with multiple identity providers. In such examples, the ISVs may use the cloud platform 195-b, which may enable FastFed, SAML, and SCIM to be transparent for the ISVs. For example, the ISVs may integrate applications with the cloud platform 195-b and use one or more authentication and management SDKs (e.g., provided by the cloud platform 195-b). In such an example, the cloud platform 195-b may implement FastFed standards, integrate with SAML, and support inbound SCIM provisioning. In some examples, the identity management system 120 may provide one or more resources for multi-tenant SaaS applications. For example, the identity management system 120 may combine the cloud platforms 195 to provide capabilities, such as the marketplace in which users may install applications (e.g., trial or purchase) with SSO or provisioning, or both. In some examples, the marketplace may provide a framework for certifying enterprise readiness qualities.

In some examples, users of an organization 196 or an organization 196 may use a specific plan of a version (e.g., a subscription version) of an application 110. As described herein, a developer of an application 110 may use a data management system (e.g., which includes the identity management system 120 that includes the cloud platforms 195) to manage the plans and versions (e.g., subscription versions that define the plans of an application 110) of an application. The techniques of the present disclosure may describe techniques providing the data management system the capability of managing the entitlement setup of an application 110 to be used by an entitlement management system. As such, the identity management system 120 and the entitlement management system may use the techniques of the present disclosure to users of the applications 110 have the correct access based on the plan and version of an application a user or organization 196 is subscribed to. The data management system may also be capable of managing the integration between a respective application 110 and a transaction processing and subscription management platform that is described elsewhere herein.

In some cases, the types of users of the applications 110 may be different. For example, a first type of user that manages the applications 110 for an organization via the cloud platform 195-a may be referred to as an IT admin. A second type of user that works with the cloud platform 195-b may develop or create the applications 110 and may be referred to as a developer. A third type of user that uses an application 110 may be referred to as an end user. Further, a fourth type of user that manages an application may be referred to as an application administrator.

In some examples, the application administrator and the end user may be the same user. For example, an application 110 may be a business-to-consumer (B2C) application where the application may be directly used and managed by the user that uses the application. In other words, the end user and the app administrator may both manage and use the application. In another case, an application 110 may be a business-to-business (B2B) application where the application 110 may be managed by an organization 196 to be used by the members of the organization 196. In some examples, the application administrator and the end user may be the same user for a B2B application as well. For example, at least one user of an organization 196 may use the B2B application as an end user and may manage the B2B application to be used by other users of the organization 196 as an application administrator. In some other examples, an end user may be unable to manage the B2B application for the organization 196 that the end user belongs to and thus the application admin and the end user for the B2B application may be different users. In some cases, such B2B applications may be accessed via a user interface that provides access to one or more applications 110 or can be accessed alone (e.g., via an Internet browser, a desktop application, and the like). For either a B2C application or a B2B application, the application administrator may be the user that is capable of managing which plan and version of an application 110 that an organization 196 or an end user (e.g., when the end user and the application administrator are the same user) may subscribe to. As such, the application administrator may manage the subscription plan of an application as described elsewhere herein.

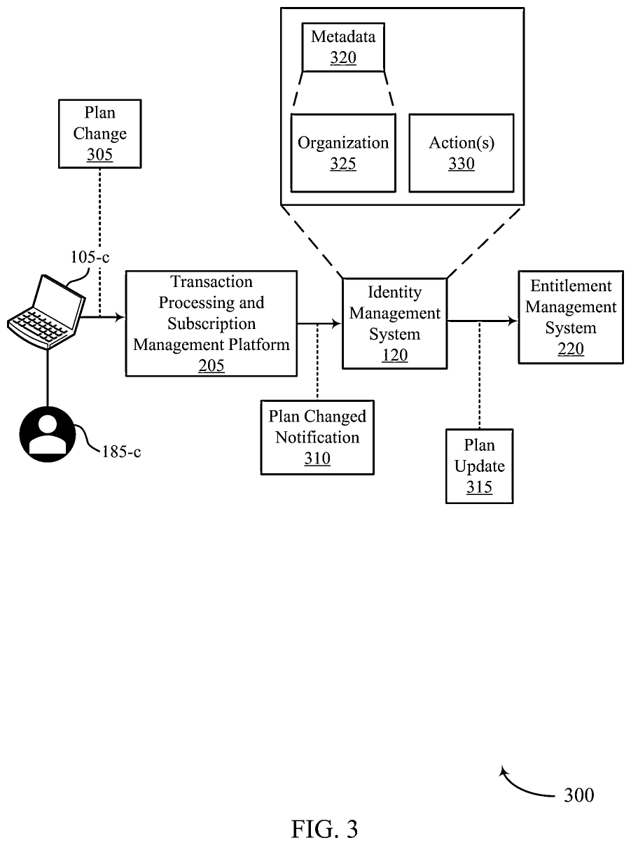

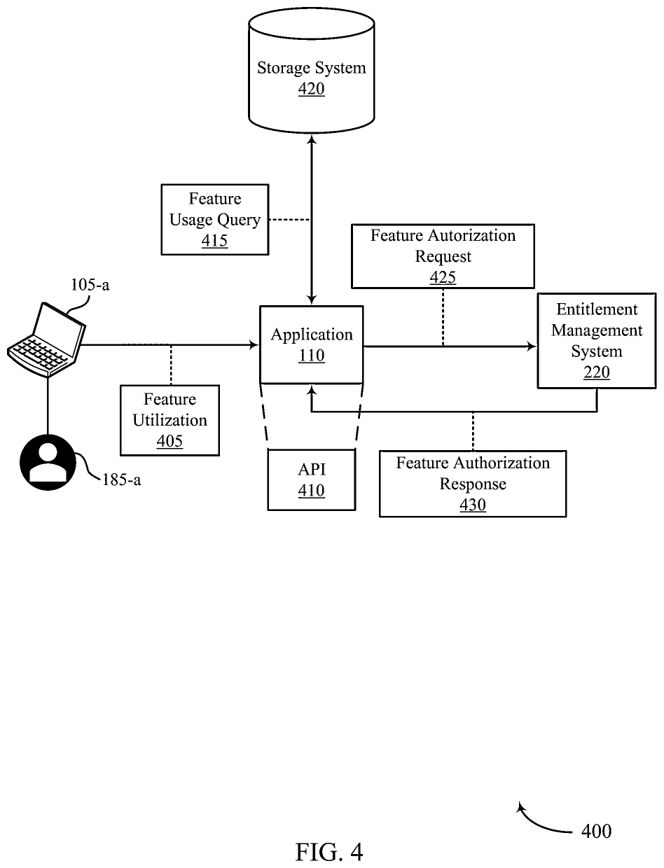

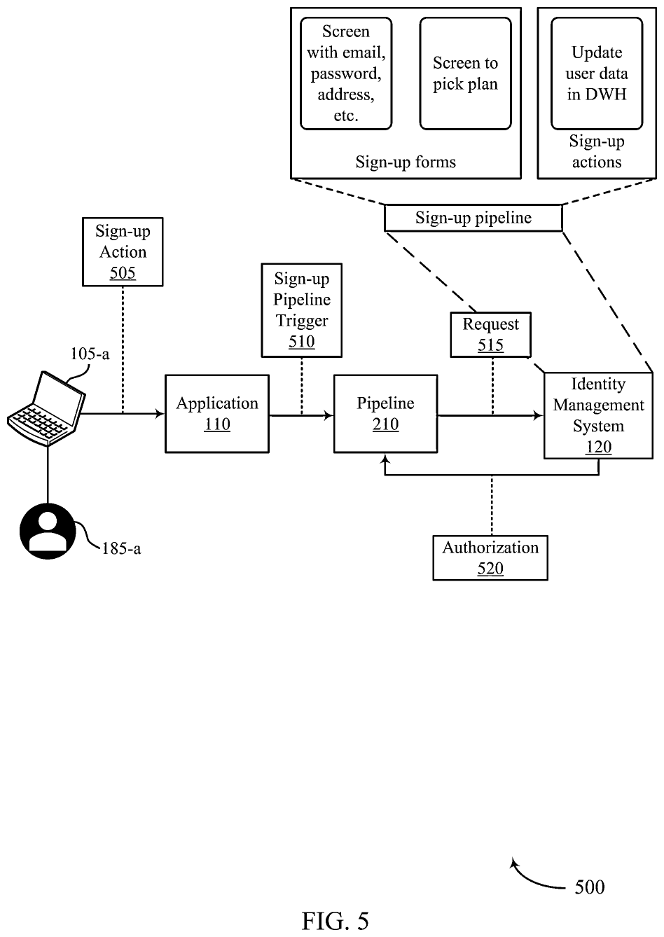

Further descriptions of the different types of users using, managing, or developing an application may be described elsewhere herein. For example, with reference to FIG. 2, a developer may create an application 110 and define a subscription version of an application to define one or more plans that an end user or organization 196 may subscribe to. Further, FIG. 3 may illustrate an end user or application administrator changing the plan of a version of an application 110 that the end user or an organization 196 subscribes to. FIGS. 4 and 5 may illustrate an end user using an application 110 via a subscription plan that an end user or an organization 196 (e.g., the organization 196 that the end user belongs to) subscribes to. As such, the techniques of the present disclosure may describe the capabilities and integrations provided to a data management system to allow the data management system to provide developers with efficient and reliable techniques of managing the plans and versions of applications 110.

FIG. 2 shows an example of a data management system 200 that supports techniques for simplifying identity management implementations related to application subscription management in accordance with aspects of the present disclosure. In some examples, the data management system 200 may implement or be implemented by the computing system 100. For example, the data management system 200 may include inputs from a computing device 105-b (such as a desktop, laptop, smartphone, tablet, or the like) operated by a user 185-b and an identity management system 120 as described with reference to FIG. 1A. In some examples, as described herein the user 185-b may correspond to a developer of an application 110. Further, as described herein an organization may be associated with one or more users 185-a that use the application 110 (e.g., end users) and the term “user” or “end user” may refer to both the organization as whole and the respective users 185-a that belong to the organization.

In some examples of the data management system 200, application 110 plans (including free, trial, paid configurations), and pricing for the plans may be integrated by the identity management system 120. For example, the identity management system 120 may configure an integration with a transaction processing and subscription management platform 205 which is used for subscription management and billing and configure one or more pipelines 210 related to authentication, plan/seat enforcement, and the like within the identity management system 120. The identity management system 120 may also generate an entitlement setup 215 for an entitlement management system 220 to use for entitlement management. In some examples, the entitlement management system 220 may also be referred to as an FGA elsewhere herein. As such, the data management system 200 may use the identity management system 120, the integrations and configuration made by the identity management system 120, and the entitlement management system 220, to manage an application (e.g., a SaaS) application.

In some cases, managing the entitlement of an application 110 and different plans and versions of an application 110 may come with a series of challenges. For example, when authorizing users 185-a (e.g., end users) access to an application 110, the application 110 may have to check the user's entitlement(s) to determine the access control of the application. Further, as users 185-a change plans that they subscribe to, the entitlement management may have to keep track of such changes to ensure that the users 185-a have the correct access to the application 110. Additionally, or alternatively, there may be custom workflows to be configured, such as updating other data sources (e.g., a data warehouse) or applications (e.g. a CRM) when specific events occur that change a user's plan. Moreover, such challenges may be further complicated as an additional version of plans of an application are implemented and there may be a first subset of users 185-a using plans of a version of an application 110 and a second subset of users 185-a using plans of a second version of the application 110. Such scenarios may have to then be accounted for by a developer user 185-b of an application 110 which may be relatively inefficient for developer users 185-b.

Therefore, developer users 185-b may use the techniques of the present disclosure via using the identity management system 120 of the data management system 200 to implement pricing models (e.g., pricing versions and respective pricing plans for the pricing versions), subscription management, and entitlement management using the identity management system 120 and the entitlement management system 220. For example, a developer user 185-b may create a subscription schema 225 to define a version (e.g., a first pricing version) of an application 110 that contains a set of plans of the version of the application 110 and their associated billing. The developer user 185-b may use a computing device 105 to then transmit the subscription schema 225 to the identity management system 120. In some cases, the identity management system may receive the subscription schema 225 via an API call from another program that has the data associated with the subscription schema stored. Further, in some examples, the other program or application 110 may be an example of a dashboard or user interface used by the developer user 185-b As such, the identity management system 120 of the data management system 200 may receive data from the subscription schema 225 for the version of an application 110 associated with the data management system 200. The subscription schema 225 may also include a set of features sets for a set of plans of the version of the application 110.

In some examples, after receiving the subscription schema 225 the identity management system 120 may configure the integration with the transaction processing and subscription management platform 205 and the application 110, configure the one or more pipelines 210 for the application 110, and generate the entitlement setup 215 for the application 110 to be used by the entitlement management system 220. In some examples, the entitlement setup 215 may be a partial entitlement setup 215. For example, the entitlement setup 215 may be general for the application 110 and not be for a specific user or organization. After a user 185-a or organization subscribes to a respective plan of the application 110, the entitlement setup 215 may be completed to include details about the entitlement for the user or organization based on the plan of the application 110 that has been selected or assigned. Further, in some cases, the application 110 may be a B2B application 110, a B2C application 110, or any combination thereof (e.g., an application 110 that is both a B2B application 110 and a B2C application 110). A B2B application 110 may be an example of an application 110 created and configured by one business to be used by another business and a B2C application 110 may be an example of an application 110 created and configured by a business to be used by consumers directly. As such, the users 185-a of a B2B application 110 may be companies or organizations and the users 185-a of a B2C application may be individuals.

In some cases, a developer user 185-b of an organization creating a B2B or a B2C application 110 may use the techniques of the present disclosure to use the data management system 200 to define the pricing and plans for the respective application 110. For example, the user 185-b which may be referred to as developer user elsewhere herein, may create a subscription schema 225 of a version of the application 110 which may define a first plan (e.g., a basic plan), a second plan (e.g., a pro plan), and a third plan (e.g., an enterprise plan) for the version of the application 110. In some examples, the first plan of the version of the application 110 may be a free plan and the second plan and the third plan of the application 110 may be paid plans (e.g., may expect payment to use). The subscription schema 225 may also include a set of feature sets for each plan of the version of the application 110. That is, the subscription schema 225 may define the features of the application 110 that can be used by the respective plans of the version of the application 110. For example, the first plan (e.g., the free plan) of the version of the application 110 may indicate that a user 185-a (e.g., an end user) is limited to creating three projects within the application and limited to a storage capacity of two gigabytes (GB). However, the second plan (e.g., the paid pro plan) of the version of the application 110 may include all the features of the first plan and include the capability for a user 185-a to use a SSO service (e.g., the SSO service 155) and a MFA service (e.g., the MFA service 160) while being capable of creating an unlimited quantity of projects with a limit of 15 GB of storage and a 30 day version history. In some cases, an application administrator may configure whether a user 185-a is capable of using the SSO service 155 and/or the MFA service 160. Additionally, or alternatively, a user 185-a may be expected to use the SSO service 155 and/or the MFA service 160. Further, the subscription schema 225 may include seat billing information for a set of plans of a respective version of an application 110. For example, the seat billing information may indicate which types of seats (e.g., based on user roles or total vs active in a time period) or accounts of a subscription plan may be billable.

In some examples, the identity management system 120 and the transaction processing and subscription management platform 205 may also manage multiple versions of an application 110 via additional subscription schemas 225. For example, a developer user 185-b may define a version of the application 110 via a first subscription schema 225 and a second version of the application via a second subscription schema 225. As such, organizations or users 185-a using the application 110 may migrate between plans of a respective version of the application 110, between active versions of the application 110, or any combination thereof. For example, a user 185-a of the application 110 may change from a free plan of the first version of the application 110 set of plans to a paid plan of the second (and currently “active”) version of the application 110 set of plans. Moreover, since there may be different versions (e.g., pricing or subscription versions) of the application 110, the identity management system 120 may have to manage the multiple different versions of the application 110. Therefore, the identity management system 120 may be capable of having users 185-a use different versions of the same application 110.

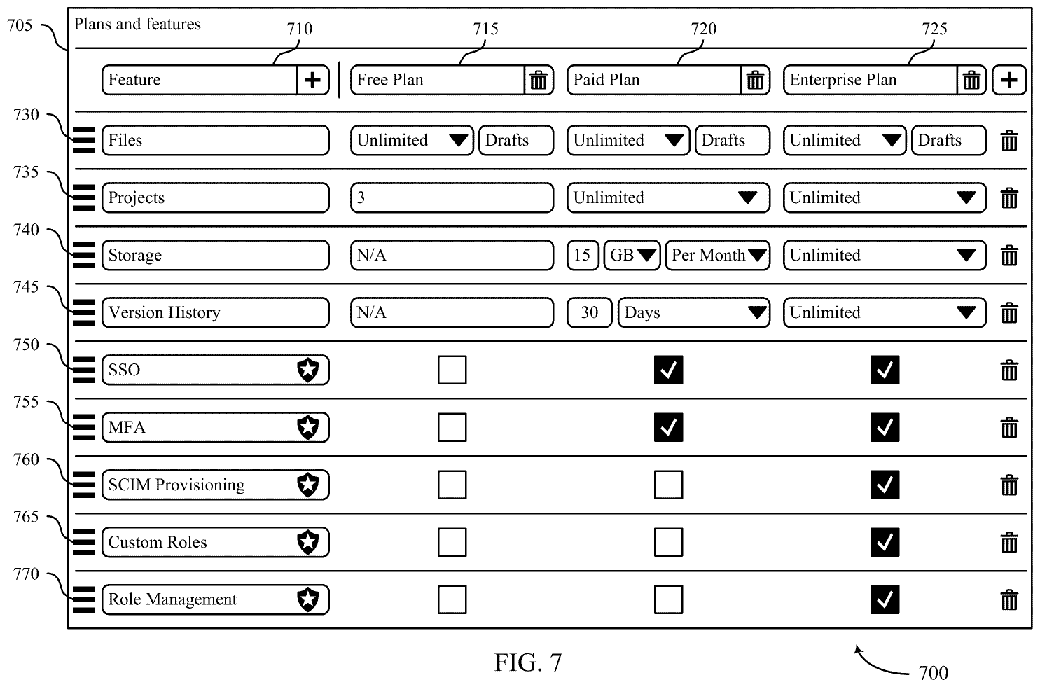

In some cases (generally, but not exclusively B2B cases), the subscription schema 225 may also indicate whether a respective plan has a seat limit (e.g., a limited quantity of accounts associated with respective users 185-a) and if so the subscription schema 225 can also indicate either a minimum quantity of accounts and a maximum quantity of accounts (or both). For example, a free plan of the version of the application may have a maximum of five seats (e.g., accounts). Additionally, or alternatively, the free plan of the version of the application 110 may also include a maximum quantity of seats (e.g., three seats) for a respective role (e.g., an editor role). That is, the free plan of the version of the application 110 may have a limit of three accounts assigned with an editor role. Further, the subscription schema 225 may also define the pricing of each respective plan of the version of the application 110 to be invoiced and charged by the transaction processing and subscription management platform 205. For example, the subscription schema 225 may define a monthly cost, an annual cost, a cost per seat (e.g., per account), or any combination thereof for each respective plan of the version of the application 110 indicated in the subscription schema 225. Further descriptions of the types of features a respective plan of a respective version of an application 110 may implement or support, the features that may be indicated via the subscription schema 225, or both, may be described elsewhere herein including with reference to FIG. 7.

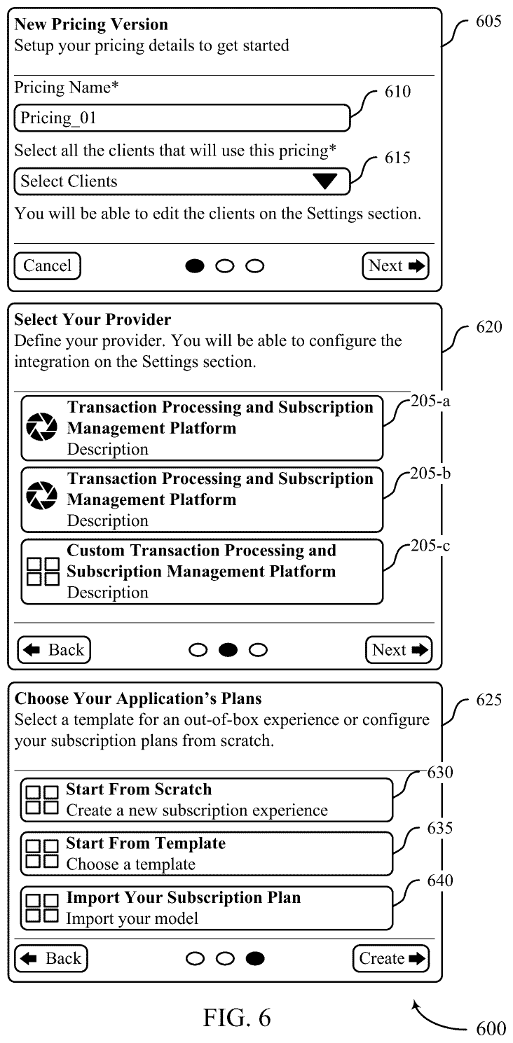

Further, to support the different plans of a version of an application 110 where some of the plans are paid plans, a developer user 185-b may integrate the application 110 with a transaction processing and subscription management platform 205. Further, the identity management system 120 may integrate with the transaction processing and subscription management platform 205 such that identity management system 120 is capable of transmitting (e.g., pushing) and receiving (e.g., pulling) data from the transaction processing and subscription management platform 205. The integration between the application 110 and the transaction processing and subscription management platform 205 may allow for pricing and billing information to be exchanged between the application 110 and the transaction processing and subscription management platform 205. In some examples, when creating the application 110, a developer user 185-b of the identity management system 120 may select the transaction processing and subscription management platform 205. For example, the identity management system 120 may be integrated with one or more transaction processing and subscription management platforms 205 and a developer user 185-b can select from the one or more transaction processing and subscription management platforms 205 that are integrated with the identity management system 120. As such, the developer user 185-b may select a first transaction processing and subscription management platform 205 for a first version (e.g., subscription or pricing version) of an application 110 and a second transaction processing and subscription management platform 205 for a second version of the application 110. Additionally, or alternatively, the developer user 185-b may also select to use a custom integration to a transaction processing and subscription management platform 205. That is, the developer user 18-b may create the custom integration for a transaction processing and subscription management platform 205 that is not natively supported by the identity management system 120. Such selection of the transaction processing and subscription management platform 205 may be described elsewhere herein with reference to FIGS. 3 and 6. Once selected, the identity management system 120 may configure the integration between the application 110 and the selected transaction processing and subscription management platform 205. In some cases, such integration may include configuring the transaction processing and subscription management platform 205 with the different plans for the respective version of the application 110 indicated via the subscription schema 225 and the respective prices for the plans.

In some examples, the integration may also include subscribing the application 110 to webhooks (or similar mechanisms that allow the transaction processing and subscription management platform 205 to communicate events happening to respective users 185-a to other platforms or services) for subscription changes detected by the transaction processing and subscription management platform 205. For example, a webhook may be an HTTP request that is triggered by an event in the transaction processing and subscription management platform 205 and sent to the application 110. For example, a user 185-a of the application 110 may change from the first plan of the version of the application 110 (e.g., the free plan) to the second plan of the version of the application 110 (e.g., the pro plan). As such, the transaction processing and subscription management platform 205 may collect payment information from the user 185-a which may be an example of an event that then automatically triggers a message to be transmitted to the application 110. The message may indicate that there has been a change in the plan the user 185-a is subscribing to which therefore changes the entitlement of the user 185-a for the application 110. Thus, the application 110 may forward the message or the indication to the identity management system 120 or some other system, platform, or service of the data management system 200 such that the entitlement setup 215 can be updated to provide the user 185-a the correct access to the application 110. Similarly, the user 185-a may downgrade from the third plan to the second plan and the entitlement setup 215 may be updated accordingly to remove access to some features of the application 110 for the user 185-a. Further description of the flow of when a user 185-c (e.g., an application administrator which may be the same or different from an end user) changes the plan of an application 110 that the user 185-a subscribes to may be described with reference to FIG. 3.

Following the selection of the transaction processing and subscription management platform 205 and the identity management system 120 integrating the application 110 with the selected transaction processing and subscription management platform 205, the developer user 185-b of the application 110 may configure the one or more pipelines 210 of the application 110 for the identity management system 120 to implement. That is, the one or more pipelines 210 may be a part of the identity management system 120 and implemented by the identity management system 120. In some examples, the one or more pipelines 210 may include pipelines for sign up flow plans, seat limit enforcements, login flow plans, and the like. For a sign-up flow plan, the corresponding pipeline 210 may indicate the actions to be implemented by the application 110 when a user 185-a creates an account for the application 110 (e.g., signs up for an account). In some examples, the pipeline 210 for the developer user 185-b of the application 110 may configure the sign-up flow to determine which plans of the version of the application 110 a user 185-a can select from after creating an account for the application 110. In some cases, a user 185-a may be automatically assigned the first plan of the version of the application 110 after creating an account for the application 110. In some other cases, the identity management system 120 may prompt the user 185-a to select a plan from the set of plans of the version of the application 110 (e.g., the first plan, the second plan, or the third plan). In cases where a user 185-a selects a plan of the version of the application 110 that is a paid plan (e.g., the second plan or the third plan), the pipeline 210 for the sign-up flow may direct the user 185-a to a payment page. The payment page may then have one or more fields for the user 185-a to input payment information to be sent to the transaction processing and subscription management platform 205.

Additionally, or alternatively, the user 185-a may be prompted to create a set of login credentials to access the account of the application 110. Such login credentials may include an email address, a phone number, a username, a password, a passphrase, a PIN, an answer to one or more security questions, or any combination thereof. The identity management system 120 may then store the login credentials within the identity management system 120 to be used when authorizing a user 185-a access to an account of the application 110. For example, after logging into an account of the application 110, the corresponding user 185-a of the account may provide the login credentials of the account which the identity management system 120 may then send to an authorization server to determine if the user 185-a is authorized to access the account of the application 110. In some cases, the authorization server may authorize the user 185-a to access the account of the application 110. In some other cases, the authorization server may deny the user 185-a access to the account of the application 110.

In some examples, when a user 185-a attempts to create an account for the application 110 or sign up for an account of the application 110, the user 185-a may be denied authorization to do so. For example, a user 185-a may attempt to create an account using a license of an application 110 owned by an organization that has a limited quantity of accounts available based on the plan of the application 110 the organization subscribes. As such, a sign-up or sign-in pipeline 210 may use the entitlement management system 220 to determine if the plan of the application 110 can support an additional account. If a threshold quantity of accounts for the plan has been reached, the user 185-a may be unable to create an account unless the organization changes which plan of the application 110 the organization subscribes for, the organization removes a seat (e.g., account), or both. Further description of such pipeline 210 may be described elsewhere here including with reference to FIG. 5.

Moreover, based on the subscription schema 225 indicating one or more plans of a respective version of the application 110 and the identity management system 120 configuring the pipelines 210 of the application, the identity management system 120 may generate the entitlement setup 215. The entitlement setup 215 may be based on the data of the subscription schema 225 that includes the features sets for each respective plan of the version of the application 110. As such, the identity management system 120 may configure the entitlement management system 220 with the entitlement setup 215 based on the plans and features for the plans defined by the subscription schema 225 and based on the configuration of the one or more pipelines 210. Further description of an application 110 using the entitlement management system 220 to determine whether a respective user 185-a can make use of a feature of the application 110 may be described elsewhere herein, including with reference to FIG. 4.

Therefore, by using the data management system 200, developer users 185-b may create applications 110 with subscription or pricing versions that include multiple plans for the identity management system 120 to manage. The identity management system 120 may then manage the subscription management via notifications (e.g., webhooks) from the transaction processing and subscription management platform 205. The identity management system 120 may also manage the entitlement management of the application 110 via the entitlement management system 220. Further descriptions of the techniques of the present disclosure implementing the data management system 200 may be described elsewhere herein. In the example of FIG. 3, the data management system 200 may update the entitlement setup 215 used by the entitlement management system 220 based on a user 185-c (which may be the same as a user 185-a) changing which plan of the application 110 is being used. As described with reference to FIG. 4, the entitlement management system 220 of the data management system 200 may authorize or deny a request from a user 185-a to make use of a feature of an application 110.

FIG. 3 shows an example of a data management system 300 that supports techniques for simplifying identity management implementations related to application subscription management in accordance with aspects of the present disclosure. In some examples, the data management system 300 may implement or be implemented by the computing system 100 and/or the data management system 200. The data management system 300 may use the identity management system 120 and receive inputs from a computing device 105-c (such as a desktop, laptop, smartphone, tablet, or the like) operated by a user 185-c as described with reference to FIG. 1A and make use of the transaction processing and subscription management platform 205 and the entitlement management system 220 as described with reference to FIG. 2. For example, FIG. 3 may illustrate the user 185-c changing plans of an application 110 via the transaction processing and subscription management platform 205 and the data management system 300 using the identity management system 120 to update the entitlement of the user 185 via the entitlement management system 220.

In some examples, a user 185 (e.g., the user 185-c) of a plan or a version (e.g., a subscription version or pricing version) of an application 110 may change which plan the user 185-a or the organization of the user 185 subscribes to. As such, the user 185-c may be referred to as an application administrator since the user 185-c is capable of managing the plan of an application 110 that an end user (e.g., a user 185-a) or organization subscribes to. For example, the user 185-c may initiate a plan change 305 on a computing device 105-c via the transaction processing and subscription management platform 205. That is, the user 185-c may use the transaction processing and subscription management platform 205 that is integrated with the application 110 to change from a first plan of the version of the application 110 to a second plan of the version of the application 110. As such, the identity management system 120 may receive a plan changed notification 310 from the transaction processing and subscription management platform 205 that indicates a change to the subscription plan for the account associated with the user 185-c. In some cases, as described elsewhere herein, the user 185-c and the user 185-a may be the same user 185 or different users 185. For example, if an end user (e.g., a user 185-a) is capable of changing the plan of the application 110 that the end user subscribes to or uses, the end user may also be considered an application administrator (e.g., a user 185-c).

The plan changed notification 310 may indicate a change of the subscription plan from a first plan of the version of the application 110 to a second plan of the version of the application 110, a change from a plan of a first version (e.g., a first subscription version) of the application 110 to a plan of a second version (e.g., a second subscription version) of the application 110, or an indication of an initial selection of a plan of a respective version of the application 110. In some cases, the plan changed notification 310 may be transmitted from the transaction processing and subscription management platform 205 to the identity management system 120 in the form of a webhook notification as described with reference to FIG. 2.

In some cases, the user 185-c may initiate the plan change 305 of the application 110 via a billing page or tab of the application 110. The billing page of the application 110 may show the user 185-c the plan that the user 185-c currently subscribes to and give the user 185-c an option to change plans. The user 185-c may be able to view the different plans of the version of the application 110 that is currently active and view the features that the different plans of the version of the application 110 support. Further, if the user 185-c initiates the plan change 305 from a free plan to a paid plan, the user 185-c may provide payment information to the transaction processing and subscription management platform 205 which may then initiate the plan changed notification 310 to be transmitted from the transaction processing and subscription management platform 205 to the identity management system 120. Additionally, or alternatively, the payment information may be stored within the transaction processing and subscription management platform 205 and the user 185-c may use the stored payment information or add additional payment information to be used.

Based on the plan being changed, the identity management system 120 may reconfigure the metadata 320 of an organization 325 that the user 185-c belongs to accordingly. In some examples, the user 185-c may be associated with an account of the organization 325. As such, the organization 325 may be an example of a business, a company, or any other type of group or team that may have multiple users 185 (e.g., end users or users 185-a) of a respective application 110. Therefore, as illustrated herein, the user 185-c may be a member of the organization 325 and may initiate a plan change 305 for the respective account associated with the user 185-c. For example, the user 185-c may currently be using a free plan of a version of the application 110 and may initiate the plan change 305 to change to a paid plan of the version of the application 110. As such, the identity management system 120 may change the metadata 320 of the organization 325 to indicate that the user 185-c has changed to a different plan. Further, it should be understood, the metadata 320 for a respective organization 325 may be managed by the identity management system 120 where the identity management system 120 may manage metadata 320 for multiple different organizations 325. In some other examples, the identity management system 120 may generate a token that includes the plan data for a user 185-a or an organization 325. Such token may be used to authenticate which plan of the application 110 a user 185-a may use.

Further, the identity management system 120 may also indicate a plan update 315 to the entitlement management system 220 to update the entitlement setup 215 of the application 110 for the organization 325. The identity management system 120 may update the entitlement setup 215 to ensure that users 185-a of the organization 325 are capable of making use of the features of the plan that the organization 325 subscribes to. For example, the organization 325 may initiate the plan change 305 to change the subscription plan of the organization 325 from a first plan of a version of an application 110 to a second plan of the version of the application 110 that supports a feature of the application 110 that the first plan fails to support. As such, the entitlement management system 220 may be updated to support the plan of the application 110 that the user 185-c is subscribed to.

Moreover, once the plan change 305 is executed, one or more actions 330 may be executed via the identity management system 120. For example, the one or more actions 330 may include the subscription plan of a user 185-a or organization being changed, executing custom code when a plan is changed to enable sending notifications to the users 185-a of the organization 325, updating a database or data warehouse (DWH) based on the subscription plan of the organization 325, or any combination thereof, or both changing the subscription plan and executing the custom code. Further, in some cases, after the plan change 305 is initiated for an organization 325, a user 185-a may attempt to make use of a feature of the application 110 that was unsupported by the plan the organization 325 subscribed to prior to the plan change 305. As such, the entitlement management system 220 may determine whether the respective features of the application 110 is supported by the plan the organization 325 has changed to when a user 185-a requests to use a respective feature. Further description of such procedure may be described elsewhere herein including with reference to FIG. 4.

FIG. 4 shows an example of a data management system 400 that supports techniques for simplifying identity management implementations related to application subscription management in accordance with aspects of the present disclosure. In some examples, the data management system 400 may implement or be implemented by the computing system 100, the data management system 200, and/or the data management system 300. The data management system 400 may receive inputs from a computing device 105-a (such as a desktop, laptop, smartphone, tablet, or the like) operated by a user 185-a as described with reference to FIG. 1A and make use of the entitlement management system 220 as described with reference to FIG. 2. For example, FIG. 4 may illustrate a user 185-a attempting to make use of a feature of an application 110 (e.g., by performing a feature utilization 405) that triggers a feature authorization request 425 to be transmitted via an API 410 of the application 110 and the entitlement management system 220 determining the feature authorization response 430 for the request from the user 185-a.

In some examples, a user 185-a (e.g., an end user of an application 110) may perform a feature utilization 405 to attempt to make use of a feature of the application 110. For example, the feature utilization 405 may include the user 185-a attempting to create a project within the application 110. As part of the feature utilization 405, the application 110 may use an API 410 to transmit a feature usage query 415 to a storage system 420 to determine how many projects the user 185-a currently has within the application 110. In some cases, the feature usage query 415 may also include an organization that the user 185-a belongs to and any other contextual necessary data (such as time period, date, etc.) to determine usage for the feature for the plan the user 185-a is subscribed to. As such, the storage system 420 may return the quantity of projects the user 185-a has within the application 110.

Using the return value of the feature usage query 415, the API 410 may transmit a feature authorization request 425 to the entitlement management system 220 to determine if the feature utilization 405 is allowed. The entitlement management system 220 may then determine whether to provide the feature authorization response 430 to the user 185-a of the application 110. In some cases, the feature authorization request 425 may indicate the quantity of projects that the user 185-a currently has. Using such information, the entitlement management system 220 may determine whether creating an additional project would satisfy or exceed a threshold quantity of projects. For example, based on the respective plan and version (e.g., a subscription version or pricing version) of the application 110 that the organization of the user 185-a or the user 185-a subscribes to, there may be a threshold quantity of projects (e.g., a maximum quantity of projects) a user 185-a may have at one time within the application 110. In some examples, such threshold may have a quantitative value (e.g., a threshold of three projects). In some other examples, the threshold may be infinity (e.g., there is no limit to the quantity of projects the user 185-a may have within the application 110). Therefore, if the plan of the application 110 the user 185-a is subscribed to indicates a threshold quantity of projects and adding an additional project would exceed the threshold quantity of projects, the entitlement management system 220 may reply saying “no” or “denied” in the feature authorization response 430 for the user 185-a to create an additional project.

Moreover, if the plan of the application 110 refrains from indicating a threshold quantity of projects or if adding an additional project would not exceed the threshold quantity of projects, the entitlement management system 220 may reply “yes” or “allowed” in the feature authorization response 430 to the user 185-a to create the additional project. Further, there may be a view within the application 110 that may illustrate to the user 185-a the quantity of active projects the user 185-a has within the application 110 and the maximum quantity of active projects the user 185-a is capable of having within the application 110. As such, if the user attempts to perform a feature utilization 405 to create an additional project and the current quantity of projects is equal to the maximum quantity of projects, the user 185-a may be unable to create the additional project and may be displayed such information. For example, the user 185-a may receive a prompt that indicates that a threshold quantity of projects has been reached and to create an additional project the user 185-a may have to change to or subscribe to a different plan of the application, as described with reference to FIG. 3.

As such, the data management system 400 illustrated herein may use the techniques of the present disclosure to perform the feature usage queries 415 to the storage system 420 and feature authorization requests 425 to the entitlement management system 220 via the API 410 to determine if a feature utilization 405 is valid. Further description of the techniques of the present disclosure may be described elsewhere herein including with reference to FIG. 5, which may illustrate a pipeline 210 of the one or more pipelines 210 used by the identity management system 120.

FIG. 5 shows an example of a data management system 500 that supports techniques for simplifying identity management implementations related to application subscription management in accordance with aspects of the present disclosure. In some examples, the data management system 500 may implement or be implemented by the computing system 100, the data management system 200, the data management system 300, and/or the data management system 400. The data management system 500 may use the identity management system 120 and receive inputs from a computing device 105-a (such as a desktop, laptop, smartphone, tablet, or the like) operated by a user 185-a as described with reference to FIG. 1A and make use of the one or more pipelines 210 of an application 110 as described with reference to FIG. 2. For example, FIG. 5 may illustrate a user 185-a (e.g., an end user of an application 110) performing a sign-up action 505 to sign up for an account of the application 110 which may trigger a sign up pipeline trigger 510 at the application 110. As such, a pipeline 210 of the one or more pipelines 210 of the application 110 may be initiated where a request 515 is transmitted to the identity management system 120 to determine whether to provide authorization 520 for the request 515 from the user 185-a.

In some examples, a user 185-a of an organization may perform a sign-up action 505 via a computing device 105 to sign up for an account of an application 110. Such action may be part of a signup pipeline which may be one of the one or more pipelines 210. As such, the sign-up action 505 for the application 110 may include a user clicking on a link or button within the application 110 or within an external service or application. For example, the user 185-a may receive an email via an email client that provides a link to sign up for an account of the application 110 which may then direct the user 185-a to a sign-up page of the application 110. In other cases, the user 185-a may click or select a button within the application 110 to be directed to a sign-up page of the application 110. The sign-up page of the application 110 may direct the user 185-a to input information within one or more fields. For example, there may be fields for the user 185-a to input a name (e.g., first name, middle name/initial, last name, or any combination thereof), an email address, a phone number, a password, or any combination thereof. Such information may then be used and stored as the login credentials for the user 185-a as described elsewhere herein. In some cases, the information associated with the user 185-a may then be stored within a DWH. Additionally, or alternatively, if the DWH has data stored for the user 185-a, the user data may be updated accordingly.

After inputting or before inputting such information, by the user 185-a selecting to sign up for an account of the application 110, a sign-up pipeline trigger 510 may be triggered. The sign-up pipeline trigger 510 may then initiate at least one pipeline 210 of the one or more pipelines 210 of the application 110. For example, the at least one pipeline 210 may be a sign-up pipeline 210. In some examples, the sign-up pipeline 210 may first determine if the user 185-a belongs to an organization and is attempting to create an account under the subscription plan of the application 110 associated with the organization. For example, the organization may subscribe to a plan of the application 110 that has a seat limit. That is, there may be a maximum quantity of seats (e.g., accounts) that the organization may have within the application 110.

As such, the sign-up pipeline 210 may transmit a request 515 to the identity management system 120 to determine whether the user 185-a can be granted authorization 520 to sign up for an account using the subscription plan of the organization associated with the user 185-a. The identity management system 120 may then make use of the entitlement management system 220 to determine if a threshold quantity of accounts has been reached for the respective plan subscribed to by the organization associated with the user 185-a. In some cases, the identity management system 120 and the entitlement management system 220 may determine that the seat limit for the plan of the application 110 the organization associated with the user 185-a subscribes to has been reached. Thus, the identity management system 120 may refrain from providing the authorization 520 to the user 185-a to sign up for an account of the application 110. In some other cases, the identity management system 120 and the entitlement management system 220 may determine that the seat limit has not been reached (e.g., a threshold quantity of seats will not be exceeded) or determine that the plan that the organization associated with the user 185-a subscribes to has no seat limit. As such, the identity management system 120 may provide the authorization 520 to the user 185-a therefore enabling the user 185-a to sign up for an account of the application 110 using the subscription plan of the organization associated with the user 185-a.

In some other examples, the user 185-a may not belong to an organization, or the user 185-a may be a member of an organization that does not have a subscription plan of the application 110. As such, the user 185-a may trigger the sign-up pipeline trigger 510 to initiate the sign up pipeline 210. In some cases, the sign-up pipeline 210 may assign the user 185-a a plan of the respective version (e.g., a subscription version or pricing version) of the application 110. For example, the user 185-a may be automatically assigned a plan (e.g., the free plan) of the application 110 after creating an account of the application 110. In some other cases, after creating an account of the application 110, the user 185-a may be prompted to select between one or more different plans of the respective version of the application 110. In some examples, the one or more different plans may include a free plan and one or more paid plans for the user 185-a to select between. Additionally, or alternatively, the application 110 may give the user 185-a a free trial for one or more of the plans of the application 110. That is, the user 185-a may be able to use one of the plans of the application 110 for a period of time while refraining from paying for the respective plan. Such free trials may be limited for a period of time (e.g., a week, a month, six months), a period of uses (e.g., the trial expires after three uses), or both. As such, since the user 185-a may select which plan of the application 110 to subscribe to, the user 185-a may be an application administrator (e.g., user 185-c) for the application 110.

In some examples, there may be other types of pipelines 210 supported by the data management system 500. For example, there may be a sign in pipeline 210. The sign in pipeline 210 may enable the identity management system 120 to prevent a user 185-a from signing into an application 110 if the organization the user 185-a belongs to has reached a maximum quantity of seats for the subscription plan of the organization. In some examples, such maximum quantity of seats may also refer to billable seats as described elsewhere herein. As part of the sign in pipeline 210, a developer user 185-b may configure one or more actions to occur based on determining that a user 185-a is being denied access to an account (e.g., the user is unable to sign in). For example, the user 185-a may receive a display of an error page on a computing device 105 or a display of a page to upgrade plans for the version of the application 110. In some other cases, the sign in pipeline 210 may either automatically alert (e.g., via a push notification, a text message, an email, or any combination thereof) the purchaser or owner of the account (e.g., the user 185-a of an organization that controls the subscription plan of the application 110) to change plans or give an option to the user 185-a to send the alert.

Additionally, or alternatively, the identity management system 120 may manage a sign-up pipeline. In some cases, the sign-up pipeline may be considered as a part of the identity management system 120 and thus can be managed or adapted via the identity management system 120. In some examples, the sign-up pipeline of the identity management system 120 may be initiated with the user 185-a (which may also be a user 185-c described with reference to FIG. 4) by selecting a link with an email (e.g., an invite to sign-up for an account of the application 110) or selecting a button within the application 110 (e.g., a “sign-up” button). As such, the identity management system 120 may redirect the user to one or more sign-up forms. In some examples, a first sign-up form may include a screen with text fields for a user to input an email address, a username, a password, an address, or any combination thereof. In some other examples, a second sign-up form may include a screen for the user 185-a to pick a plan of a respective version (e.g., subscription version) of an application 110. Further, the sign-up pipeline of the identity management system 120 may then perform one or more sign-up actions. For example, a first action (e.g., an action performed by the identity management system 120 and implemented by a developer user 185-b or installed through the identity management system 120 marketplace) for the may be for the identity management system 120 to update the user data stored in a DWH to include the date entered or selected within the sign-up forms of the sign-up pipeline of the identity management system 120.

Therefore, the techniques of the present disclosure may provide users 185-a a sign-up pipeline 210 which may also determine whether a respective user 185-a is allowed to create an account for the application 110. It should be understood that there may also be other types of pipelines 210 that the application 110 may use (e.g., a sign in pipeline, a pricing pipeline, or a subscription pipeline). Further descriptions of the techniques may be described elsewhere herein including with reference to FIGS. 6 and 7.

FIG. 6 shows an example of user interfaces 600 that supports techniques for simplifying identity management implementations related to application subscription management in accordance with aspects of the present disclosure. In some examples, the user interfaces 600 may implement or be implemented by the computing system 100, the data management system 200, the data management system 300, the data management system 400, and/or the data management system 500. For example, the user interfaces 600 may illustrate a developer user 185-b defining which clients a pricing model may apply to via a user interface 605, integrating with a transaction processing and subscription management platform 205 via a user interface 620, and the developer user 185-b selecting how to start working on the pricing model (e.g., subscription schema 225) to be used for an application 110 via a user interface 625.

In some examples, the pricing versions of application 110 may also be referred to as the versions of the application. For example, as described elsewhere herein, an application 110 may have one or more versions (e.g., pricing or subscription version) which may change over time to include different plans with additional features compared to a previous version. Therefore, the pricing version configuration illustrated herein within the user interfaces 600 may be a part of the configuration of a respective version of an application 110.

As such, in the user interface 605, a developer user 185-b may define a name of the pricing version of an application 110 within a text field 610. The text field 610 may be a field in which a user 185-b may input text (e.g., a string of characters) to create a name for the respective pricing version. As described elsewhere herein, the user 185-a may refer to an end user of an application 110 and the user 185-b may refer to a developer of an application 110. The user 185-b may also select the clients that may use the pricing version within a field 615. The field 615 may include a drop-down menu of multiple different clients that the user 185-b may select from those clients in the identity management system 120. For example, the drop-down menu of the field 615 may allow the user 185-b to select from a specific web application 110, a specific iOS application 110, a specific Android application 110, or any other client in the identity management system 120. Further, the user 185-b may select more than one client that will use the respective pricing version.

The user 185-b may then use the user interface 620 to select a respective transaction processing and subscription management platform 205 (e.g., a transaction processing and subscription management platform 205-a, a transaction processing and subscription management platform 205-b, or a transaction processing and subscription management platform 205-c) to be integrated with the application 110 by the developer user 185-b. In some examples, the transaction processing and subscription management platform 205-a integration and the transaction processing and subscription management platform 205-b integration may be already supported by the identity management system 120. That is, the respective transaction processing and subscription management platforms 205 may be supported by or already integrated with the identity management system 120.

Further, the transaction processing and subscription management platform 205-c may be integrated with a custom integration via the data management platform using a custom integration for the transaction processing and subscription management platform 205-c. For example, the integration for the transaction processing and subscription management platform 205-c may be an integration with a transaction processing and subscription management platform 205 from a third party, in some cases may be installed from a marketplace. In other examples, the custom integration for the data management system may be created, implemented and configured by the user 185-b. In some cases, to support custom features the user 185-b may design the integration from scratch and configure the transaction processing and subscription management platform 205-c within the user interface 620. Therefore, if the user 185-b wants to use a transaction processing and subscription management platform 205 that a data management system (e.g., the data management system 200, the data management system 300, the data management system 400, and/or the data management system 500) does not support (e.g., the transaction processing and subscription management platform 205-c), the user 185-b may develop the custom integration for the transaction processing and subscription management platform 205-c between the transaction processing and subscription management platform 205 and data management system.

Further in some examples, the plans of an application may be described as a subscription schema 225 elsewhere herein. That is, the plans of an application defined by the subscription schema 225 may define the feature sets for each respective plan of a respective version (e.g., a pricing version) of an application 110. As such, within the user interface 625 the user 185-b may select between starting from an empty state (e.g., a custom subscription plan 630) where they have to define all plans and features, a template subscription plan 635 from an available set of templates, or an imported subscription plan 640. The custom subscription plan 630 may be an example of a subscription schema 225 that is generated or created by the user 185-b (e.g., the custom subscription plan 630 may be empty). The creation or generation of the custom subscription plan 630 may be further illustrated and described elsewhere herein including with reference to FIG. 7. Further, in some cases, the user 185-b may select the template subscription plan 635 to select a subscription schema 225 created by the user 185-b or available to be selected by the user 185-b. In some examples, the template subscription plan 635 may include plan names and one or more suggestions for features of an application 110 to be supported by respective plans. Further, the imported subscription plan 640 may be a subscription schema 225 that is imported by the user 185-b from an external service or data platform. That is, the user 185-b may select the imported subscription plan 640 to import the subscription schema 225 for the respective version of the application 110 (e.g., the respective pricing version of the application 110).

Therefore, the techniques of the present disclosure may describe using the configured version of an application 110 to manage different plans of the configured version and managing different versions of the application 110. Further, the techniques of the present disclosure may include allowing a user 185-b to configure the plans of a respective version of an application 110 and the feature sets for each respective plan as described and illustrated with reference to FIG. 7.

FIG. 7 shows an example of a user interface 700 that supports techniques for simplifying identity management implementations related to application subscription management in accordance with aspects of the present disclosure. In some examples, the user interface 700 may implement or be implemented by the computing system 100, the data management system 200, the data management system 300, the data management system 400, and/or the data management system 500. For example, the user interfaces 700 may illustrate the set of features of a respective version of an application 110 and how the feature sets for each plan of the respective version of the application 110 are defined.

In some examples, the user interface 700 may illustrate a configuration page 705 to configure the plans and features of a respective version (e.g., subscription or pricing version) of an application 110. The configuration page 705 may be used by a user 185-b (e.g., a developer) to configure one or more plans and the respective feature sets for each plan for the respective version of the application 110. As such, a user 185-b may use the configuration page 705 to add features via an add feature field 710 for the configuration of the one or more plans of the respective version of the application 110 (e.g., a first plan 715, a second plan 720, or a third plan 725). In some cases, the first plan 715 may be a free plan, the second plan 720 may be a paid plan, and the third plan 725 may be an enterprise plan. The configuration page 705 may also include an add plan field that may be selected to add additional plans to the respective version of the application 110. Further, the configuration page 705 may also provide the user 185-b the capability to remove a plan or feature (e.g., as illustrated via a trash can symbol).

As such, a user 185-b may use the configuration page 705 of the user interface 700 to configure one or more features for the first plan 715, the second plan 720, and the third plan 725. In some examples, a subset of the features of the one or more features may be associated with a quantitative value, a quantitative value and a respective unit for the quantitative value, a quantitative value and a respective period of time, or any combination thereof. For example, a first feature 730 of the one or more features may define a quantity of files for each respective plan. As illustrated herein, the first feature 730 may be configured such that each plan is configured with an unlimited quantity of draft files. A second feature 735 of the one or more features may define a quantity of projects for each respective plan. As such, the second feature 735 may configure the first plan 715 with a threshold quantity of 3 projects and the second plan 720 and third plan 725 with an unlimited quantity of projects. Further, a third feature 740 may be illustrated as the quantity of storage each respective plan has. In some cases, the first plan 715 may be configured with no storage, the second plan 720 may be configured with a quantity of storage for a period of time (e.g., 15 GB per month), and the third plan 725 may be configured with an unlimited amount of storage. Moreover, a fourth feature 745 may define how long of a version history a respective plan may be configured with. As such, the first plan 715 may not be configured with any version history, the second plan 720 may be configured with a 30-day version history, and the third plan 725 may be configured with an unlimited version history.

In some other examples, the remainder of the features of the one or more features configured via the configuration page 705 in the user interface 700 may be configured as Boolean features. That is, the features may either be supported or unsupported by the respective plans. Further, as illustrated by the star symbol next to the name of the remainder features, in some cases, the identity management system 120 may configure and manage the respective Boolean features. That is, the star symbol may indicate which features of an application 110 will be managed by the identity management system 120. Moreover, to indicate whether a respective plan supports a fifth feature 750 (e.g., supports the SSO service 155), a sixth feature 755 (e.g., supports the MFA service 160), supports a seventh feature 760 (e.g., supports a provisioning service 175 for a system for cross-domain identity management (SCIM) provisioning), an eight feature 765 (e.g., supports custom roles), a ninth feature 770 (e.g., supports role management), or any combination thereof, the configuration page 705 may have a checkmark for each respective feature and each respective plan. As such, to indicate that a respective Boolean feature is supported by a respective plan, a corresponding checkbox may be selected where a checkmark indicates that the respective plan supports the respective feature. Further, in some examples, the custom roles of the eight feature 765 may indicate that a user 185 (e.g., a developer user 185-b or an application administrator user 185-c) can create roles for an application that are not in the application's out of the box supported role set, to assign levels of access to a user 185-a. For example, the roles may include a viewer role that corresponds to a read only access, an editor role that corresponds to read/write access, an admin role that corresponds to a full level of access or control of the respective application 110, or any other type of role that determines a level of access and control of an application 110.

As such, the configuration page 705 of the user interface 700 may illustrate a subscription schema 225 generated by a user 185-b for a respective version of an application 110. For example, the configuration page 705 illustrates which features each respective plan supports for the respective version of the application 110. Additionally, or alternatively, the subscription schema may be generated by the user 185-b via code that is transmitted to the identity management system 120 via an API. In some examples, subsequent versions (e.g., subscription or pricing versions) of an application 110 may be defined by the subscription schema 225 illustrated in the configuration page 705 being edited or reconfigured. Additionally, or alternatively, a respective plan of a version of the application 110 may be billed on a per monthly active user 185-a (e.g., a user 185-a that logged in during the last monthly billing period) basis. For example, opposed to using the transaction processing and subscription management platform 205 to bill the application 110 based on each user using the application, an organization may be billed per monthly active user of the application 110 during the last monthly billing period. Such active users may then be associated with a billable seat. As such, an organization may be capable of having a relatively larger quantity of users 185-a with accounts of the application 110 granted that the quantity of monthly active users 185-a refrains from exceeding a threshold quantity as indicated via accessing the application during a billing period.

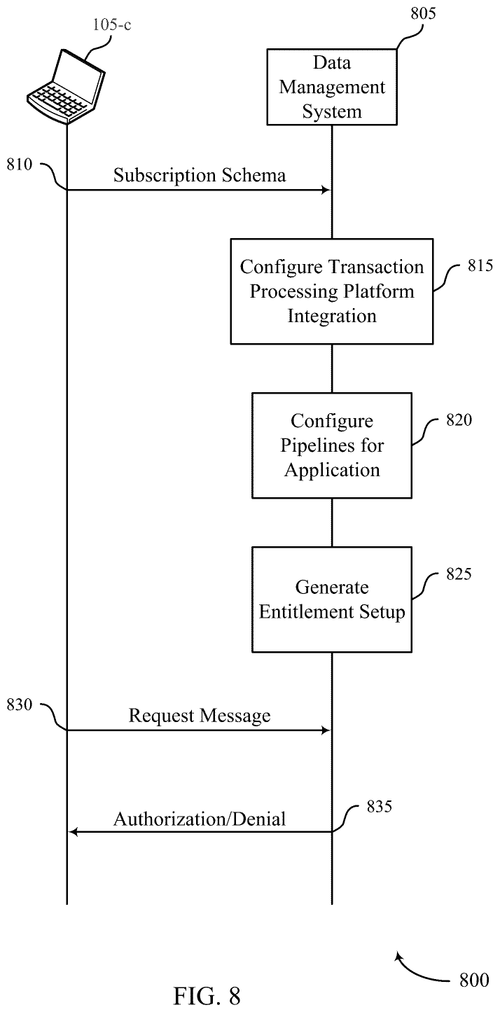

Moreover, the addition of additional features or change in support for a feature or level of support for a feature may constitute the generation of a different subscription or pricing version of the application 110. Some versions of the application 110 may include relatively minor edits or additions whereas others may include relatively larger edits or additions. Further descriptions of using such subscription schema 225 configured via the user interface 700 may be described elsewhere herein in accordance with the techniques of the present disclosure. For example, further descriptions of the techniques of the present disclosure may be described with reference to FIG. 8.

FIG. 8 shows an example of a process flow 800 that supports techniques for simplifying identity management implementations related to application subscription management in accordance with aspects of the present disclosure. In some examples, the process flow 800 may implement or be implemented by the computing system 100, the data management system 200, the data management system 300, the data management system 400, and/or the data management system 500. For example, the process flow 800 may use the data management system 805 and receive inputs from a computing device 105-c (such as a desktop, laptop, smartphone, tablet, or the like) operated by a user 185 as described with reference to FIG. 1A. In some cases, such inputs may be received via an API. Further, in some examples, the user 185 may be a user 185-a (e.g., an end user), a user 185-b (e.g., a developer), or a user 185-c (e.g., an application administrator), as described elsewhere herein. In some other examples, the identity management system 120 may be a first subsystem of the data management system 805 and the entitlement management system 220 may be a second subsystem of the data management system 805.

In the following description of the process flow 800, the operations between the computing device 105-c and the identity management system 120 may be performed in different orders or at different times. Some operations may also be left out of the process flow 800, or other operations may be added. Although the computing device 105-c and the identity management system 120 are shown performing the operations of the process flow 800, some aspects of some operations may also be performed by one or more other devices, services, or models described elsewhere herein including with reference to FIG. 1A.

At 810, the data management system 805 may receive, from a user of the computing device 105-c, data corresponding to a subscription schema for a version of an application 110 of a set of versions of the application 110 associated with a data management system (e.g., the data management system 805). The subscription schema may include a set of feature sets for a set of plans of the version of the application 110. Further, the identity management system 120 may be a first subsystem of the data management system. In some examples, the data corresponding to the subscription schema for the version of the application 110 may be imported. As such, the identity management system 120 may import the data corresponding to the subscription schema of the version of the application 110 from an external service connected to the data management system. Further, in some cases, a feature set for a respective plan of the version of the application 110 may include a quantitative value and a corresponding to unit for the quantitative value, one or more features associated with a quantitative value and a corresponding period of time for the quantitative value, one or more features associated with a quantitative value and both a corresponding unit for the quantitative value and a corresponding period of time for the quantitative value, or any combination thereof. In some other cases, a feature set for a respective plan of the version of the application 110 may include one or more features with a Boolean value indicating whether a respective feature is configured within the respective feature set of the respective plan of the version of the application 110. Additionally, or alternatively, at least one of the set of feature sets may include one or more authentication features supported by the identity management system 120 of the data management system.

At 815, the data management system 805 may configure, via the identity management system 120 of the data management system 805, an integration between the application 110 and a transaction processing and subscription management platform connected to the data management system 805. In some cases, the configuration may include a user selecting the transaction processing and subscription management platform from a set of transaction processing and subscription management platforms that are associated with the identity management system 120 of the data management system. In some other cases, the integration between the application 110 and the transaction processing and subscription management platform may be configured by an administrative user of the identity management system 120 of the data management system. Additionally, or alternatively, the identity management system 120 may transmit to the transaction processing and subscription management platform, an indication of a quantity of users associated with billable seats (e.g., accounts being paid for) of the subscription plan of the version of the application.

At 820, the data management system 805 may configure, via the identity management system 120 of the data management system 805, one or more pipelines for the application 110 in accordance with one or more parameters associated with the subscription schema for the version of the application 110. In some cases, configuring the one or more pipelines may include the identity management system 120 receiving a first input associated with the one or more parameters that control which plans of the set of plans of the version of the application 110 are available for users to subscribe to as part of a signup pipeline. Moreover, the one or more pipelines may include the signup pipeline, a sign in pipeline, a subscription pipeline, or any other type of pipeline. Further, in some examples, the identity management system 120 may receive a second input, from the user associated with the account, requesting to subscribe to a first plan of the set of plans of the version of the application 110 as the subscription plan of the account in accordance with the signup pipeline. As such, authorizing or denying a request, via an entitlement management system which may be a second subsystem of the data management system, may be based on the second input that assigns the first plan of the version of the application 110 to the account. In some other examples, the identity management system 120 may assign a first plan of the set of plans of the version of the application 110 as the subscription plan of the account associated with the user in accordance with the one or more pipelines. As such, authorizing or denying, via the entitlement management system, a request is based on the first plan being assigned as the subscription plan of the account.

At 825, the data management system 805 may generate, via the identity management system 120 of the data management system 805, an entitlement setup for the version of the application 110 based on the set of feature sets for the set of plans of the version of the application 110. The entitlement setup may be generated for the entitlement management system which is a second subsystem of the data management system and is integrated with the identity management system 120. Further, the entitlement setup generated by the identity management system 120 may define which users or organizations are authorized to access one or more features of a respective plan of the set of plans of the version of the application 110.

At 830, the data management system 805 may receive, from an application being used by a user 185-a of the computing device 105-c, data associated with a request to create, update, or remove a subscription plan for an account associated with a user via the one or more pipelines for the application 110. As such, at 835, the entitlement management system may authorize or deny the request from the application being used by the user 185-a of the computing device 105-c based on the entitlement setup for the version of the application 110. In some cases, the data management system may obtain, from the identity management system 120, a token that includes one or more data items. In some examples, the one or more data items may include a subscription identifier associated with the account. As such, the entitlement management system may authorize or deny the request based on at least one of the one or more data items of the token. Further, in one example, the application 110 may obtain a token from the identity management system 120 and the application 110 may ask questions to the entitlement management system to pass some of the data in the token (e.g. the user 185 ID, the organization ID, or both) as well as the action that the user 185 wants to take (feature they want to use) and what they want to take it on. As such, in some cases, the identity management system 120 may receive the one or more data items in some other manner (e.g., via a database query, via a message, via accessing a memory storage location, or any combination thereof).

In some other cases, an application associated with the data management system 805 may receive, from the entitlement management system, a first indication of a user permission status (e.g., userHasPermission parameter) that is obtained from an authorization service of the identity management system. The first indication of the user permission status may be associated with the request and an organization permission status (e.g., organizationHasPermission parameter) associated with the request. Moreover, the organization permission status may be set by the entitlement management system and may determine if the subscription plan of an organization that a user 185 belongs to can support a respective feature if an application.

In some examples, the identity management system 120 may receive an input associated with enabling a first plan of the version of the application from the set of plans of the version of the application 110. Further, the input may enable the subscription plan for the account associated with the user to be the first plan of the version of the application 110. In some other examples, the identity management system 120 may receive, via the integration between the identity management system 120 and the transaction processing and subscription management platform, an indication of a change to the subscription plan for the account associated with the user from the first plan of the version of the application 110 to a second plan of the version of the application 110 from the set of plans of the version of the application 110. In either example, the entitlement management system may update the entitlement setup based on the input or the change of the subscription plan for the account associated with the user from the first plan of the version of the application 110 to the second plan of the version of the application 110 respectively.

In another example, the entitlement management system may receive data associated with a request, from the user associated with the account, to make use of a feature of a feature set of the subscription plan of the account associated with the user. As such, in some cases, the entitlement management system may determine that the feature of the feature set of the subscription plan of the account for the version of the application 110 satisfies a threshold. Therefore, the identity management system 120 may transmit, to the user of the computing device 105-c associated with the account, an indication that the threshold of the feature of the feature set of the subscription plan is satisfied. In some cases, the indication may include one or more options associated with changing the subscription plan of the account associated with the user to a different plan of the set of plans of the version of the application 110 based on the threshold being satisfied.

In some other examples, the data management system 805 may receive data associated with a request, from the user associated with the account, to use a feature set of the subscription plan of the account associated with the user. As such, in some cases, the entitlement management system may determine that the feature set of the subscription plan of the account is unsupported based on the entitlement setup. Therefore, the identity management system 120 may transmit, to the user of the computing device 105-c associated with the account, an indication that the feature of the feature set is unsupported by the subscription plan of the account. Further, in some cases the indication may include one or more options associated with changing the subscription plan of the account to a different plan of the plurality of plans of the version of the application 110 that supports the feature.

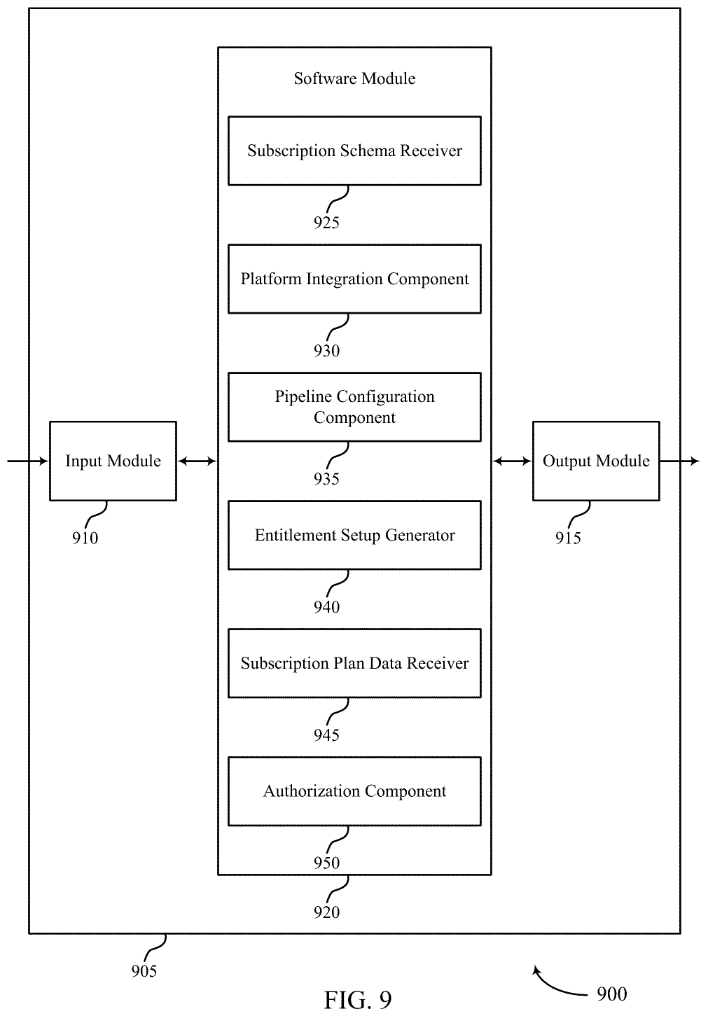

FIG. 9 shows a block diagram 900 of a device 905 that supports techniques for simplifying identity management implementations related to application subscription management in accordance with aspects of the present disclosure. The device 905 may include an input module 910, an output module 915, and a software module 920. The device 905, or one of more components of the device 905 (e.g., the input module 910, the output module 915, and the software module 920), may include at least one processor, which may be coupled with at least one memory, to support the described techniques. Each of these components may be in communication with one another (e.g., via one or more buses).

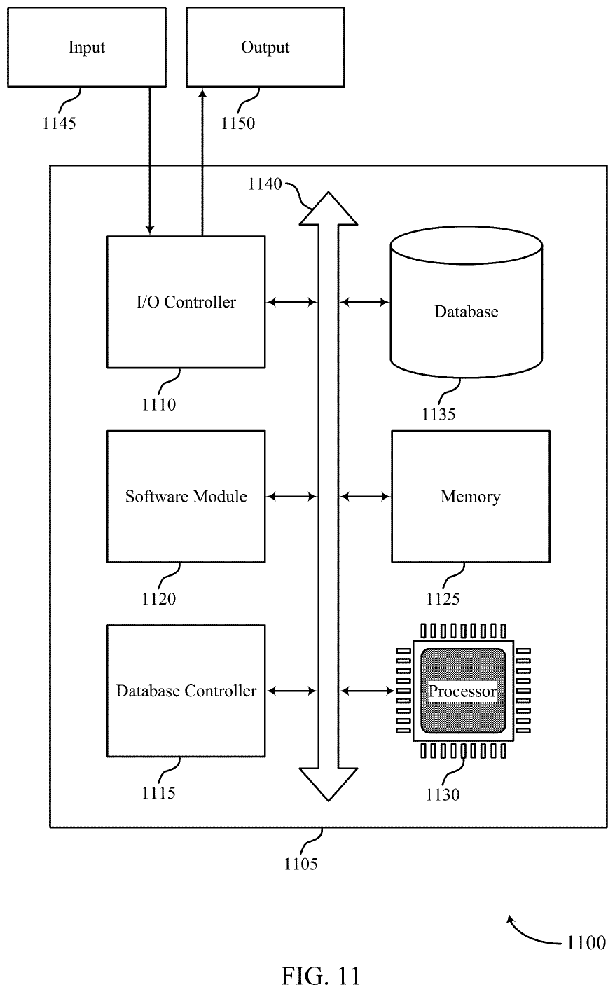

The input module 910 may manage input signals for the device 905. For example, the input module 910 may identify input signals based on an interaction with a modem, a keyboard, a mouse, a touchscreen, or a similar device. These input signals may be associated with user input or processing at other components or devices. In some cases, the input module 910 may utilize an operating system such as iOS®, ANDROID®, MS-DOS®, MS-WINDOWS®, OS/2®, UNIX®, LINUX®, or another known operating system to handle input signals. The input module 910 may send aspects of these input signals to other components of the device 905 for processing. For example, the input module 910 may transmit input signals to the software module 920 to support techniques for simplifying identity management implementations related to application subscription management. In some cases, the input module 910 may be a component of an input/output (I/O) controller 1110 as described with reference to FIG. 11.

The output module 915 may manage output signals for the device 905. For example, the output module 915 may receive signals from other components of the device 905, such as the software module 920, and may transmit these signals to other components or devices. In some examples, the output module 915 may transmit output signals for display in a user interface, for storage in a database or data store, for further processing at a server or server cluster, or for any other processes at any number of devices or systems. In some cases, the output module 915 may be a component of an I/O controller 1110 as described with reference to FIG. 11.

For example, the software module 920 may include a subscription schema receiver 925, a platform integration component 930, a pipeline configuration component 935, an entitlement setup generator 940, a subscription plan data receiver 945, an authorization component 950, or any combination thereof. In some examples, the software module 920, or various components thereof, may be configured to perform various operations (e.g., receiving, monitoring, transmitting) using or otherwise in cooperation with the input module 910, the output module 915, or both. For example, the software module 920 may receive information from the input module 910, send information to the output module 915, or be integrated in combination with the input module 910, the output module 915, or both to receive information, transmit information, or perform various other operations as described herein.

The subscription schema receiver 925 may be configured to support receiving, by an identity management system that is a first subsystem of a data management system, data corresponding to a subscription schema for a version of an application of a set of multiple versions of the application associated with the data management system, the subscription schema including a set of multiple feature sets for a set of multiple plans of the version of the application. The platform integration component 930 may be configured to support configuring, by the identity management system, an integration between the application and a transaction processing and subscription management platform connected to the data management system. The pipeline configuration component 935 may be configured to support configuring, by the identity management system, one or more pipelines for the application in accordance with one or more parameters associated with the subscription schema for the version of the application. The entitlement setup generator 940 may be configured to support generating, by the identity management system, an entitlement setup for the version of the application based on the set of multiple feature sets for the set of multiple plans of the version of the application, the entitlement setup being for an entitlement management system that is a second subsystem of the data management system and integrated with the identity management system. The subscription plan data receiver 945 may be configured to support receiving, by the identity management system, data associated with a request to create, update, or remove a subscription plan for an account associated with a user or organization via the one or more pipelines for the application. The authorization component 950 may be configured to support authorizing or denying, via the entitlement management system, the request based on the entitlement setup for the version of the application.

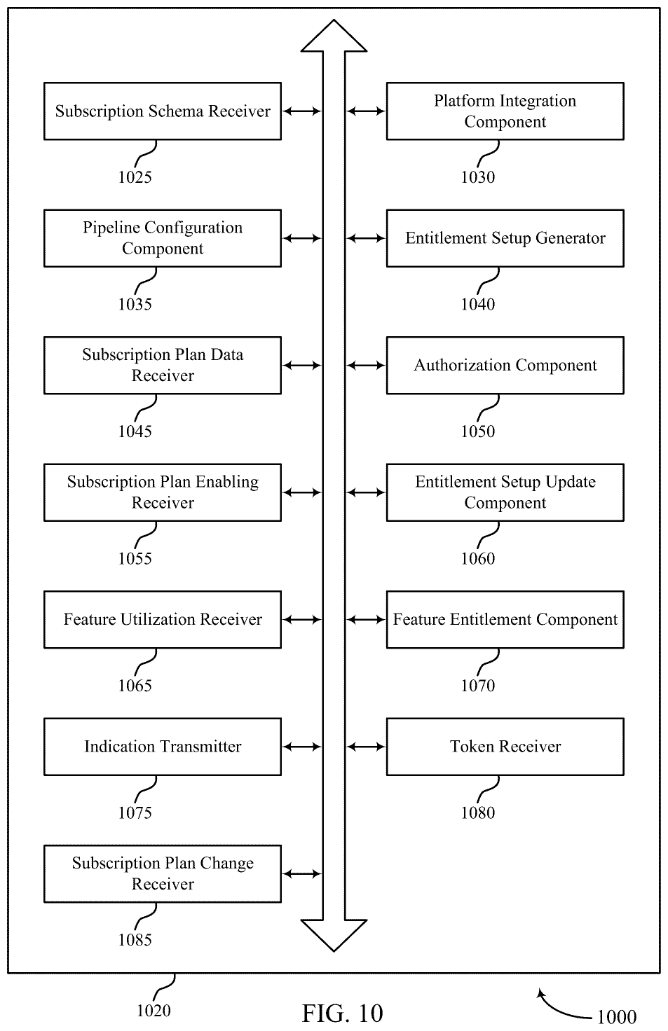

FIG. 10 shows a block diagram 1000 of a software module 1020 that supports techniques for simplifying identity management implementations related to application subscription management in accordance with aspects of the present disclosure. The software module 1020 may be an example of aspects of a software module or a software module 920, or both, as described herein. The software module 1020, or various components thereof, may be an example of means for performing various aspects of techniques for simplifying identity management implementations related to application subscription management as described herein. For example, the software module 1020 may include a subscription schema receiver 1025, a platform integration component 1030, a pipeline configuration component 1035, an entitlement setup generator 1040, a subscription plan data receiver 1045, an authorization component 1050, a subscription plan enabling receiver 1055, an entitlement setup update component 1060, a feature utilization receiver 1065, a feature entitlement component 1070, an indication transmitter 1075, a token receiver 1080, a subscription plan change receiver 1085, or any combination thereof. Each of these components, or components of subcomponents thereof (e.g., one or more processors, one or more memories), may communicate, directly or indirectly, with one another (e.g., via one or more buses).

The subscription schema receiver 1025 may be configured to support receiving, by an identity management system that is a first subsystem of a data management system, data corresponding to a subscription schema for a version of an application of a set of multiple versions of the application associated with the data management system, the subscription schema including a set of multiple feature sets for a set of multiple plans of the version of the application. The platform integration component 1030 may be configured to support configuring, by the identity management system, an integration between the application and a transaction processing and subscription management platform connected to the data management system. The pipeline configuration component 1035 may be configured to support configuring, by the identity management system, one or more pipelines for the application in accordance with one or more parameters associated with the subscription schema for the version of the application. The entitlement setup generator 1040 may be configured to support generating, by the identity management system, an entitlement setup for the version of the application based on the set of multiple feature sets for the set of multiple plans of the version of the application, the entitlement setup being for an entitlement management system that is a second subsystem of the data management system and integrated with the identity management system. The subscription plan data receiver 1045 may be configured to support receiving, by the identity management system, data associated with a request to create, update, or remove a subscription plan for an account associated with a user or organization via the one or more pipelines for the application. The authorization component 1050 may be configured to support authorizing or denying, via the entitlement management system, the request based on the entitlement setup for the version of the application.

In some examples, the subscription plan enabling receiver 1055 may be configured to support receiving, by the identity management system, an input associated with enabling a first plan of the version of the application from the set of multiple plans of the first version of the application, where the input enables the subscription plan for the account associated with the user to be the first plan of the version of the application. In some examples, the entitlement setup update component 1060 may be configured to support updating, via the entitlement management system, the entitlement setup based on the input.

In some examples, the subscription plan change receiver 1085 may be configured to support receiving, by the identity management system via the integration between the identity management system and the transaction processing and subscription management platform, an indication of a change to the subscription plan for the account associated with the user or organization from a first plan of the version of the application to a second plan of the version of the application from the set of multiple plans of the version of the application. In some examples, the entitlement setup update component 1060 may be configured to support updating, via the entitlement management system, the entitlement setup based on the change of the subscription plan for the account associated with the user from a first plan of the version of the application to a second plan of the version of the application.

In some examples, the feature utilization receiver 1065 may be configured to support receiving, from the application, data associated with a request, from the user associated with the account, to make use of an application feature of a feature set of the subscription plan of the account associated with the user, where the data associated with the request is received by the identity management system of the data management system or the entitlement management system of the data management system. In some examples, the feature entitlement component 1070 may be configured to support determining, via the entitlement management system, that the feature of the feature set of the subscription plan of the account for the version of the application satisfies a threshold. In some examples, the indication transmitter 1075 may be configured to support transmitting, to the application, an indication, from the identity management system, that the threshold of the feature of the feature set of the subscription plan is satisfied, the indication including one or more options associated with changing the subscription plan of the account associated with the user to a different plan of the set of multiple plans of the version of the application based on the threshold being satisfied.

In some examples, the feature utilization receiver 1065 may be configured to support receiving, by the identity management system from the application, the data associated with the request. In some examples, the feature entitlement component 1070 may be configured to support transmitting, from the identity management system to the entitlement management system, the data associated with the request, where the entitlement management system determining that the feature of the feature set of the subscription plan of the account for the version of the application satisfies the threshold is based on the entitlement management system receiving the data associated with the request.

In some examples, the feature utilization receiver 1065 may be configured to support receiving, by the identity management system, data associated with a request, from the user associated with the account, to use a feature set of the subscription plan of the account associated with the user. In some examples, the feature entitlement component 1070 may be configured to support determining, via the entitlement management system, that the feature of the feature set of the subscription plan of the account is unsupported based on the entitlement setup. In some examples, the indication transmitter 1075 may be configured to support transmitting, to the application, an indication, from the identity management system that the feature of the feature set is unsupported by the subscription plan of the account.

In some examples, the token receiver 1080 may be configured to support obtaining, from the identity management system, a token that includes one or more data items, the one or more data items including a subscription plan identifier associated with the account, where authorizing or denying, via the entitlement management system, the request is based on at least one of the one or more data items of the token.

In some examples, the indication transmitter 1075 may be configured to support transmitting, via the identity management system and to the transaction processing and subscription management platform, an indication of a quantity of users associated with a billable seat for the subscription plan of the version of the application.

In some examples, to support receiving the data corresponding to the subscription schema, the subscription schema receiver 1025 may be configured to support importing the data corresponding to the subscription schema for the version of the application, the data including the set of multiple feature sets for the set of multiple plans of the version of the application, where the identity management system imports the data corresponding to the subscription schema for the version of the application from an external service connected to the data management system.

In some examples, to support configuring the one or more pipelines for the application, the pipeline configuration component 1035 may be configured to support receiving, by the identity management system, a first input associated with one or more parameters that control which plans of the set of multiple plans of the version of the application are available by users to subscribe to as part of a signup pipeline, where the one or more pipelines includes the signup pipeline.

In some examples, to support configuring the one or more pipelines for the application, the pipeline configuration component 1035 may be configured to support receiving, by the identity management system, a second input, from the user associated with the account, requesting to subscribe to a first plan of the set of multiple plans of the version of the application as the subscription plan of the account in accordance with the signup pipeline, where authorizing or denying the request, via the entitlement management system, is based on the second input that assigns the first plan of the version of the application to the account.

In some examples, the one or more pipelines for the application include assigning, by the identity management system, a first plan of the set of multiple plans of the version of the application as the subscription plan of the account associated with the user in accordance with the one or more pipelines, where authorizing or denying, via the entitlement management system, the request is based on the first plan being assigned as the subscription plan of the account.

In some examples, the transaction processing and subscription management platform is selected from a set of multiple transaction processing and subscription management platforms that are associated with the identity management system of the data management system.

In some examples, a respective feature set for a respective plan of the version of the application includes one or more features associated with a quantitative value, one or more features associated with a quantitative value and a corresponding to unit for the quantitative value, one or more features associated with a quantitative value and a corresponding period of time for the quantitative value, one or more features associated with a quantitative value and both a corresponding unit for the quantitative value and a corresponding period of time for the quantitative value, or any combination thereof.

In some examples, a respective feature set for a respective plan of the version of the application includes one or more features with a Boolean value indicating whether a respective feature is configured within the respective feature set of the respective plan of the first version of the application.

In some examples, the entitlement setup generated by the identity management system defines which users or organizations are authorized to access one or more features of a respective plan of the set of multiple plans of the version of the application.

In some examples, at least one of the set of multiple feature sets includes one or more authentication features supported by the identity management system of the data management system.

FIG. 11 shows a diagram of a system 1100 including a device 1105 that supports techniques for simplifying identity management implementations related to application subscription management in accordance with aspects of the present disclosure. The device 1105 may be an example of or include the components of a device 905 as described herein. The device 1105 may include components for bi-directional voice and data communications including components for transmitting and receiving communications, such as a software module 1120, an I/O controller 1110, a database controller 1115, at least one memory 1125, at least one processor 1130, and a database 1135. These components may be in electronic communication or otherwise coupled (e.g., operatively, communicatively, functionally, electronically, electrically) via one or more buses (e.g., a bus 1140).

The I/O controller 1110 may manage input signals 1145 and output signals 1150 for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In other cases, the I/O controller 1110 may represent or interact with a modem, a keyboard, a mouse, a touchscreen, or a similar device. In some cases, the I/O controller 1110 may be implemented as part of a processor 1130. In some examples, a user may interact with the device 1105 via the I/O controller 1110 or via hardware components controlled by the I/O controller 1110.

The database controller 1115 may manage data storage and processing in a database 1135. In some cases, a user may interact with the database controller 1115. In other cases, the database controller 1115 may operate automatically without user interaction. The database 1135 may be an example of a single database, a distributed database, multiple distributed databases, a data store, a data lake, or an emergency backup database.

Memory 1125 may include random-access memory (RAM) and read-only memory (ROM). The memory 1125 may store computer-readable, computer-executable software including instructions that, when executed, cause at least one processor 1130 to perform various functions described herein. In some cases, the memory 1125 may contain, among other things, a basic I/O system (BIOS) which may control basic hardware or software operation such as the interaction with peripheral components or devices. The memory 1125 may be an example of a single memory or multiple memories. For example, the device 1105 may include one or more memories 1125.

The processor 1130 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in at least one memory 1125 to perform various functions (e.g., functions or tasks supporting techniques for simplifying identity management implementations related to application subscription management). The processor 1130 may be an example of a single processor or multiple processors. For example, the device 1105 may include one or more processors 1130.

For example, the software module 1120 may be configured to support receiving, by an identity management system that is a first subsystem of a data management system, data corresponding to a subscription schema for a version of an application of a set of multiple versions of the application associated with the data management system, the subscription schema including a set of multiple feature sets for a set of multiple plans of the version of the application. The software module 1120 may be configured to support configuring, by the identity management system, an integration between the application and a transaction processing and subscription management platform connected to the data management system. The software module 1120 may be configured to support configuring, by the identity management system, one or more pipelines for the application in accordance with one or more parameters associating with the subscription schema for the version of the application. The software module 1120 may be configured to support generating, by the identity management system, an entitlement setup for the version of the application based on the set of multiple feature sets for the set of multiple plans of the version of the application, the entitlement setup being for an entitlement management system that is a second subsystem of the data management system and integrated with the identity management system. The software module 1120 may be configured to support receiving, by the identity management system, data associated with a request to create, update, or remove a subscription plan for an account associated with a user or organization via the one or more pipelines for the application. The software module 1120 may be configured to support authorizing or denying, via the entitlement management system, the request based on the entitlement setup for the version of the application.

By including or configuring the software module 1120 in accordance with examples as described herein, the device 1105 may support techniques for using a data management system and an identity management system 120 to improve subscription management for applications 110 with multiple plans and multiple different versions (e.g., subscription or pricing versions).

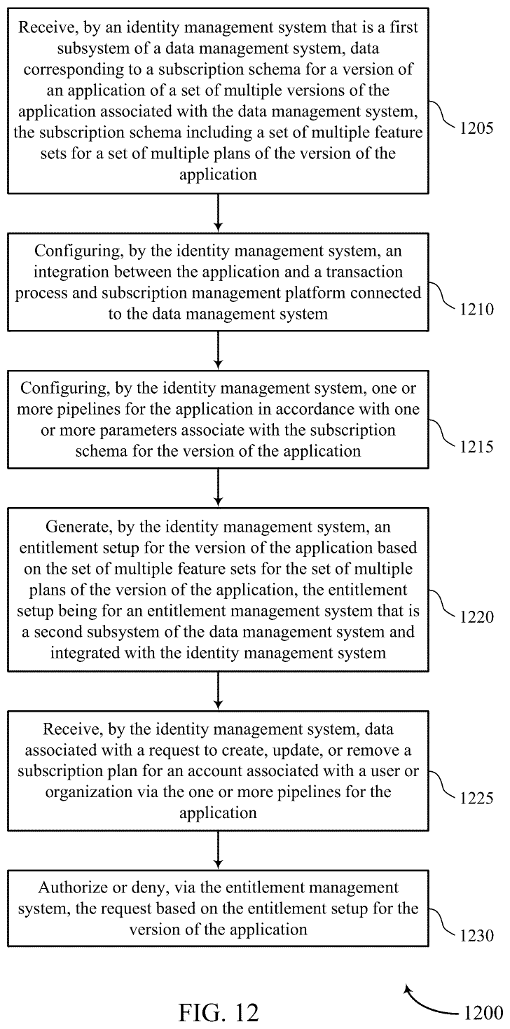

FIG. 12 shows a flowchart illustrating a method 1200 that supports techniques for simplifying identity management implementations related to application subscription management in accordance with aspects of the present disclosure. The operations of the method 1200 may be implemented by a data management system or its components as described herein. For example, the operations of the method 1200 may be performed by a data management system as described with reference to FIGS. 1 through 11. In some examples, a data management system may execute a set of instructions to control the functional elements of the data management system to perform the described functions. Additionally, or alternatively, the data management system may perform aspects of the described functions using special-purpose hardware.

At 1205, the method may include receiving, by an identity management system that is a first subsystem of a data management system, data corresponding to a subscription schema for a version of an application of a set of multiple versions of the application associated with the data management system, the subscription schema including a set of multiple feature sets for a set of multiple plans of the version of the application. The operations of block 1205 may be performed in accordance with examples as disclosed herein. In some examples, aspects of the operations of 1205 may be performed by a subscription schema receiver 1025 as described with reference to FIG. 10.

At 1210, the method may include configuring, by the identity management system, an integration between the application and a transaction processing and subscription management platform connected to the data management system. The operations of block 1210 may be performed in accordance with examples as disclosed herein. In some examples, aspects of the operations of 1210 may be performed by a platform integration component 1030 as described with reference to FIG. 10.

At 1215, the method may include configuring, by the identity management system, one or more pipelines for the application in accordance with one or more parameters associated with the subscription schema for the version of the application. The operations of block 1215 may be performed in accordance with examples as disclosed herein. In some examples, aspects of the operations of 1215 may be performed by a pipeline configuration component 1035 as described with reference to FIG. 10.

At 1220, the method may include generating, by the identity management system, an entitlement setup for the version of the application based on the set of multiple feature sets for the set of multiple plans of the version of the application, the entitlement setup being for an entitlement management system that is a second subsystem of the data management system and integrated with the identity management system. The operations of block 1220 may be performed in accordance with examples as disclosed herein. In some examples, aspects of the operations of 1220 may be performed by an entitlement setup generator 1040 as described with reference to FIG. 10.

At 1225, the method may include receiving, by the identity management system, data associated with a request to create, update, or remove a subscription plan for an account associated with a user or organization via the one or more pipelines for the application. The operations of block 1225 may be performed in accordance with examples as disclosed herein. In some examples, aspects of the operations of 1225 may be performed by a subscription plan data receiver 1045 as described with reference to FIG. 10.

At 1230, the method may include authorizing or denying, via the entitlement management system, the request based on the entitlement setup for the version of the application. The operations of block 1230 may be performed in accordance with examples as disclosed herein. In some examples, aspects of the operations of 1230 may be performed by an authorization component 1050 as described with reference to FIG. 10.

The following provides an overview of aspects of the present disclosure:

Aspect 1: A method, comprising: receiving, by an identity management system that is a first subsystem of a data management system, data corresponding to a subscription schema for a version of an application of a plurality of versions of the application associated with the data management system, the subscription schema comprising a plurality of feature sets for a plurality of plans of the version of the application; configuring, by the identity management system, an integration between the application and a transaction processing and subscription management platform connected to the data management system; configuring, by the identity management system, one or more pipelines for the application in accordance with one or more parameters associated with the subscription schema for the version of the application; generating, by the identity management system, an entitlement setup for the version of the application based at least in part on the plurality of feature sets for the plurality of plans of the version of the application, the entitlement setup being for an entitlement management system that is a second subsystem of the data management system and integrated with the identity management system; receiving, by the identity management system, data associated with a request to create, update, or remove a subscription plan for an account associated with a user or organization via the one or more pipelines for the application; and authorizing or denying, via the entitlement management system, the request based at least in part on the entitlement setup for the version of the application.

Aspect 2: The method of aspect 1, further comprising: receiving, by the identity management system, an input associated with enabling a first plan of the version of the application from the plurality of plans of the first version of the application, wherein the input enables the subscription plan for the account associated with the user to be the first plan of the version of the application; and updating, via the entitlement management system, the entitlement setup based at least in part on the input.

Aspect 3: The method of aspect 2, further comprising: receiving, by the identity management system via the integration between the identity management system and the transaction processing and subscription management platform, an indication of a change to the subscription plan for the account associated with the user or organization from a first plan of the version of the application to a second plan of the version of the application from the plurality of plans of the version of the application; and updating, via the entitlement management system, the entitlement setup based at least in part on the change of the subscription plan for the account associated with the user from a first plan of the version of the application to a second plan of the version of the application.

Aspect 4: The method of any of aspects 1 through 3, further comprising: receiving, from the application, data associated with a request, from the user associated with the account, to make use of an application feature of a feature set of the subscription plan of the account associated with the user, wherein the data associated with the request is received by the identity management system of the data management system or the entitlement management system of the data management system; determining, via the entitlement management system, that the feature of the feature set of the subscription plan of the account for the version of the application satisfies a threshold; and transmitting, to the application, an indication, from the identity management system, that the threshold of the feature of the feature set of the subscription plan is satisfied, the indication comprising one or more options associated with changing the subscription plan of the account associated with the user to a different plan of the plurality of plans of the version of the application based at least in part on the threshold being satisfied.

Aspect 5: The method of aspect 4, further comprising: receiving, by the identity management system from the application, the data associated with the request; and transmitting, from the identity management system to the entitlement management system, the data associated with the request, wherein the entitlement management system determining that the feature of the feature set of the subscription plan of the account for the version of the application satisfies the threshold is based at least in part on the entitlement management system receiving the data associated with the request.

Aspect 6: The method of any of aspects 1 through 5, further comprising: receiving, by the identity management system, data associated with a request, from the user associated with the account, to use a feature set of the subscription plan of the account associated with the user; determining, via the entitlement management system, that the feature of the feature set of the subscription plan of the account is unsupported based at least in part on the entitlement setup; and transmitting, to the application, an indication, from the identity management system that the feature of the feature set is unsupported by the subscription plan of the account.

Aspect 7: The method of any of aspects 1 through 6, further comprising: obtaining, from the identity management system, a token that comprises one or more data items, the one or more data items including a subscription plan identifier associated with the account, wherein authorizing or denying, via the entitlement management system, the request is based at least in part on at least one of the one or more data items of the token.

Aspect 8: The method of any of aspects 1 through 7, further comprising: transmitting, via the identity management system and to the transaction processing and subscription management platform, an indication of a quantity of users associated with a billable seat for the subscription plan of the version of the application.

Aspect 9: The method of any of aspects 1 through 8, wherein receiving the data corresponding to the subscription schema comprises: importing the data corresponding to the subscription schema for the version of the application, the data comprising the plurality of feature sets for the plurality of plans of the version of the application, wherein the identity management system imports the data corresponding to the subscription schema for the version of the application from an external service connected to the data management system.

Aspect 10: The method of any of aspects 1 through 9, wherein configuring the one or more pipelines for the application comprises: receiving, by the identity management system, a first input associated with one or more parameters that control which plans of the plurality of plans of the version of the application are available by users to subscribe to as part of a signup pipeline, wherein the one or more pipelines includes the signup pipeline.

Aspect 11: The method of aspect 10, wherein configuring the one or more pipelines for the application comprises: receiving, by the identity management system, a second input, from the user associated with the account, requesting to subscribe to a first plan of the plurality of plans of the version of the application as the subscription plan of the account in accordance with the signup pipeline, wherein authorizing or denying the request, via the entitlement management system, is based at least in part on the second input that assigns the first plan of the version of the application to the account.

Aspect 12: The method of any of aspects 10 through 11, wherein the one or more pipelines for the application comprise assigning, by the identity management system, a first plan of the plurality of plans of the version of the application as the subscription plan of the account associated with the user in accordance with the one or more pipelines, wherein authorizing or denying, via the entitlement management system, the request is based at least in part on the first plan being assigned as the subscription plan of the account.

Aspect 13: The method of any of aspects 1 through 12, wherein the transaction processing and subscription management platform is selected from a plurality of transaction processing and subscription management platforms that are associated with the identity management system of the data management system.

Aspect 14: The method of any of aspects 1 through 13, wherein a respective feature set for a respective plan of the version of the application includes one or more features associated with a quantitative value, one or more features associated with a quantitative value and a corresponding to unit for the quantitative value, one or more features associated with a quantitative value and a corresponding period of time for the quantitative value, one or more features associated with a quantitative value and both a corresponding unit for the quantitative value and a corresponding period of time for the quantitative value, or any combination thereof.

Aspect 15: The method of any of aspects 1 through 14, wherein a respective feature set for a respective plan of the version of the application includes one or more features with a Boolean value indicating whether a respective feature is configured within the respective feature set of the respective plan of the first version of the application.

Aspect 16: The method of any of aspects 1 through 15, wherein the entitlement setup generated by the identity management system defines which users or organizations are authorized to access one or more features of a respective plan of the plurality of plans of the version of the application.

Aspect 17: The method of any of aspects 1 through 16, wherein at least one of the plurality of feature sets comprises one or more authentication features supported by the identity management system of the data management system.

Aspect 18: An apparatus comprising one or more memories storing processor-executable code, and one or more processors coupled with the one or more memories and individually or collectively operable to execute the code to cause the apparatus to perform a method of any of aspects 1 through 17.

Aspect 19: An apparatus comprising at least one means for performing a method of any of aspects 1 through 17.

Aspect 20: A non-transitory computer-readable medium storing code the code comprising instructions executable by one or more processors to perform a method of any of aspects 1 through 17.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving, by an identity management system that is a first subsystem of a data management system, data corresponding to a subscription schema for a version of an application of a plurality of versions of the application associated with the data management system, the subscription schema comprising a plurality of feature sets for a plurality of plans of the version of the application;
configuring, by the identity management system, an integration between the application and a transaction processing and subscription management platform connected to the data management system;
configuring, by the identity management system, one or more pipelines for the application in accordance with one or more parameters associated with the subscription schema for the version of the application;
generating, by the identity management system, an entitlement setup for the version of the application based at least in part on the plurality of feature sets for the plurality of plans of the version of the application, the entitlement setup being for an entitlement management system that is a second subsystem of the data management system and integrated with the identity management system;
receiving, by the identity management system, data associated with a request to create, update, or remove a subscription plan for an account associated with a user or an organization via the one or more pipelines for the application; and
authorizing or denying, via the entitlement management system, the request based at least in part on the entitlement setup for the version of the application.

2. The method of claim 1, further comprising:
receiving, by the identity management system, an input associated with enabling a first plan of the version of the application from the plurality of plans of the version of the application, wherein the input enables the subscription plan for the account associated with the user to be the first plan of the version of the application; and
updating, via the entitlement management system, the entitlement setup based at least in part on the input.

3. The method of claim 2, further comprising:
receiving, by the identity management system via the integration between the identity management system and the transaction processing and subscription management platform, an indication of a change to the subscription plan for the account associated with the user or the organization from a first plan of the version of the application to a second plan of the version of the application from the plurality of plans of the version of the application; and
updating, via the entitlement management system, the entitlement setup based at least in part on the change of the subscription plan for the account associated with the user or the organization from the first plan of the version of the application to the second plan of the version of the application.

4. The method of claim 1, further comprising:
receiving, from the application, data associated with a request, from the user associated with the account, to make use of an application feature of a feature set of the subscription plan of the account associated with the user, wherein the data associated with the request is received by the identity management system of the data management system or the entitlement management system of the data management system;
determining, via the entitlement management system, that the application feature of the feature set of the subscription plan of the account for the version of the application satisfies a threshold; and
transmitting, to the application, an indication, from the identity management system, that the threshold of the application feature of the feature set of the subscription plan is satisfied, the indication comprising one or more options associated with changing the subscription plan of the account associated with the user to a different plan of the plurality of plans of the version of the application based at least in part on the threshold being satisfied.

5. The method of claim 4, further comprising:
receiving, by the identity management system from the application, the data associated with the request; and
transmitting, from the identity management system to the entitlement management system, the data associated with the request, wherein the entitlement management system determining that the application feature of the feature set of the subscription plan of the account for the version of the application satisfies the threshold is based at least in part on the entitlement management system receiving the data associated with the request.

6. The method of claim 1, further comprising:
receiving, by the identity management system, data associated with a request, from the user associated with the account, to use a feature set of the subscription plan of the account associated with the user;
determining, via the entitlement management system, that the feature set of the subscription plan of the account is unsupported based at least in part on the entitlement setup; and
transmitting, to the application, an indication, from the identity management system that the feature set is unsupported by the subscription plan of the account.

7. The method of claim 1, further comprising:
obtaining, from the identity management system, a token that comprises one or more data items, the one or more data items including a subscription plan identifier associated with the account, wherein authorizing or denying, via the entitlement management system, the request is based at least in part on at least one of the one or more data items of the token.

8. The method of claim 1, further comprising:
transmitting, via the identity management system and to the transaction processing and subscription management platform, an indication of a quantity of users associated with a billable seat for the subscription plan of the version of the application.

9. The method of claim 1, wherein receiving the data corresponding to the subscription schema comprises:
importing the data corresponding to the subscription schema for the version of the application, the data comprising the plurality of feature sets for the plurality of plans of the version of the application, wherein the identity management system imports the data corresponding to the subscription schema for the version of the application from an external service connected to the data management system.

10. The method of claim 1, wherein configuring the one or more pipelines for the application comprises:
receiving, by the identity management system, a first input associated with one or more parameters that control which plans of the plurality of plans of the version of the application are available by users to subscribe to as part of a signup pipeline, wherein the one or more pipelines includes the signup pipeline.

11. The method of claim 10, wherein configuring the one or more pipelines for the application comprises:
receiving, by the identity management system, a second input, from the user associated with the account, requesting to subscribe to a first plan of the plurality of plans of the version of the application as the subscription plan of the account in accordance with the signup pipeline, wherein authorizing or denying the request, via the entitlement management system, is based at least in part on the second input that assigns the first plan of the version of the application to the account.

12. The method of claim 10, wherein the one or more pipelines for the application comprise assigning, by the identity management system, a first plan of the plurality of plans of the version of the application as the subscription plan of the account associated with the user in accordance with the one or more pipelines, wherein authorizing or denying, via the entitlement management system, the request is based at least in part on the first plan being assigned as the subscription plan of the account.

13. The method of claim 1, wherein the transaction processing and subscription management platform is selected from a plurality of transaction processing and subscription management platforms that are associated with the identity management system of the data management system.

14. The method of claim 1, wherein a respective feature set for a respective plan of the version of the application includes one or more features associated with a quantitative value, one or more features associated with a quantitative value and a corresponding to unit for the quantitative value, one or more features associated with a quantitative value and a corresponding period of time for the quantitative value, one or more features associated with a quantitative value and both a corresponding unit for the quantitative value and a corresponding period of time for the quantitative value, or any combination thereof.

15. The method of claim 1, wherein a respective feature set for a respective plan of the version of the application includes one or more features with a Boolean value indicating whether a respective feature is configured within the respective feature set of the respective plan of the version of the application.

16. The method of claim 1, wherein the entitlement setup generated by the identity management system defines which users or organizations are authorized to access one or more features of a respective plan of the plurality of plans of the version of the application.

17. The method of claim 1, wherein at least one of the plurality of feature sets comprises one or more authentication features supported by the identity management system of the data management system.

18. An apparatus, comprising:
one or more memories storing processor-executable code; and
one or more processors coupled with the one or more memories and individually or collectively operable to execute the code to cause the apparatus to:
receive, by an identity management system that is a first subsystem of a data management system, data corresponding to a subscription schema for a version of an application of a plurality of versions of the application associated with the data management system, the subscription schema comprising a plurality of feature sets for a plurality of plans of the version of the application;
configuring, by the identity management system, an integration between the application and a transaction process and subscription management platform connected to the data management system;
configuring, by the identity management system, one or more pipelines for the application in accordance with one or more parameters associate with the subscription schema for the version of the application;
generate, by the identity management system, an entitlement setup for the version of the application based at least in part on the plurality of feature sets for the plurality of plans of the version of the application, the entitlement setup being for an entitlement management system that is a second subsystem of the data management system and integrated with the identity management system;
receive, by the identity management system, data associated with a request to create, update, or remove a subscription plan for an account associated with a user or organization via the one or more pipelines for the application; and
authorize or deny, via the entitlement management system, the request based at least in part on the entitlement setup for the version of the application.

19. The apparatus of claim 18, wherein the one or more processors are individually or collectively further operable to execute the code to cause the apparatus to:
receive, by the identity management system, an input associated with enabling a first plan of the version of the application from the plurality of plans of the version of the application, wherein the input enables the subscription plan for the account associated with the user to be the first plan of the version of the application; and
update, via the entitlement management system, the entitlement setup based at least in part on the input.

20. A non-transitory computer-readable medium storing code, the code comprising instructions executable by one or more processors to:
receive, by an identity management system that is a first subsystem of a data management system, data corresponding to a subscription schema for a version of an application of a plurality of versions of the application associated with the data management system, the subscription schema comprising a plurality of feature sets for a plurality of plans of the version of the application;
configuring, by the identity management system, an integration between the application and a transaction process and subscription management platform connected to the data management system;
configuring, by the identity management system, one or more pipelines for the application in accordance with one or more parameters associate with the subscription schema for the version of the application;
generate, by the identity management system, an entitlement setup for the version of the application based at least in part on the plurality of feature sets for the plurality of plans of the version of the application, the entitlement setup being for an entitlement management system that is a second subsystem of the data management system and integrated with the identity management system;
receive, by the identity management system, data associated with a request to create, update, or remove a subscription plan for an account associated with a user or organization via the one or more pipelines for the application; and
authorize or deny, via the entitlement management system, the request based at least in part on the entitlement setup for the version of the application.
